(19) United States
(12) Patent Application Publication
(10) Pub. No.: US 2006/0133223 A1
(43) Pub. Date: Jun. 22, 2006

(54) Recording medium, recording device usint the same, and reproduction device

(75) Inventors: Tadashi Nakamura, Nara-shi (JP); Yasumori Hino, Ikoma-shi (JP); Masanori Itoh, Moriguchi-shi (JP); Osamu Okauchi, Hirakata-shi (JP)

Correspondence Address: HAMRE, SCHUMANN, MUELLER & LARSON, P.C., P.O. BOX 2902-0902, MINNEAPOLIS, MN, 55402, US

(73) Assignee: Matsusuhita Electric Industrial Co., Ltd., Kadoma-shi (JP)

(21) Appl. No.: 10/541,743

(22) PCT Filed: Mar. 29, 2004
(86) PCT No.: PCT/JP04/04421

§ 371 Date: Jul. 8, 2005

(30) Foreign Application Priority Data
Mar. 28, 2003 (JP) 2003-092229

(51) Int. Cl. G11B 17/22

(52) U.S. Cl. 369/30.3

(57) ABSTRACT

A recording apparatus is provided that includes a recording section for recording information onto a recording medium, a file system processing section for managing the information as a file using file system information having a directory hierarchy structure capable of being referenced using a path name, a contents management information processing section for managing the directory and the file using contents management information, and an extension information processing section for managing extension information with respect to the directory and the file. The contents management information includes media object management information for referencing the directory and the file using object reference information obtained by converting the path name, and extended object management information for managing the extension information. The directory and the file are associated with the extension information via the object reference information.

### TECHNICAL FIELD

The present invention mainly relates to a recording apparatus, a recording method, and a recording medium recorded using the recording apparatus or the recording method, and a reproduction apparatus and a reproduction method for reproducing the recording medium. More particularly, the present invention relates to a recording/reproduction apparatus and a recording/reproduction method for recording image data or audio data as a file onto a recording medium, and a recording medium recorded using the recording/reproduction apparatus or the recording/reproduction method.

### BACKGROUND ART

Recently, AV data, such as moving image information, still image information, audio information and the like, are often recorded/reproduced in a digitized format. Examples of a recording medium accumulating such digital information include semiconductor memories, such as flash memories and the like, and disc media, such as DVD, hard disk, MD (mini disc), and the like.

AV data that is encoded using an encoding scheme such as MPEG2, JPEG or the like is recorded or reproduced onto or from the above-described recording media. In the AV data recording, each piece of AV data is managed as a file by a file system, and also in the AV data reproduction, the AV data is designated on a file-by-file basis.

An excellent feature of the above-described semiconductor media and disc media is random accessibility. By utilizing the random accessibility, recorded files can be reproduced in an arbitrary order according to the user's instruction.

The above-described technique has been further developed into a programmed reproduction function. For example, JP 2002-199335A discloses a recording/reproduction system, in which AV data is recorded as a file called a “media object”, and a plurality of media objects are recorded under a directory called a “program”. By using such a recording format, a plurality of programs can be created on a recording medium.

For each program, information called “program information (PRG_INFO)” is managed and recorded as a file that is different from a media object on a recording medium. By referencing information about media objects that is registered in PRG_INFO, the order of AV files that are recorded on a recording medium to be reproduced can be controlled freely.

The above-described function, which is generally called “programmed reproduction”, is carried out by utilizing the random accessibility of disc media.

Thus, AV data is recorded as a media object, and a program referencing the media object is also recorded as a file. In this case, reference information from the program file to the media object is required. The reference information is generally designed to indicate path information with respect to a file, that is, information representing the name and hierarchical location of the file in a file system that manages files.

An exemplary relationship between media objects and a program file is shown in FIG. 30. FIG. 30 is a diagram illustrating a directory structure of the media objects and a structure of the program file.

Each program file 10002 holds a reference to each media object 10001 in the form of a full-path name 10003 from a ROOT directory 10000. In full-path names shown in FIG. 30, a path delimiter is represented as “/”.

The above-mentioned media objects and program files are all managed by using a file system, such as UDF, FAT or the like. The file system is generally used in the architecture of a personal computer (hereinafter referred to as a “PC”). The introduction of the file system makes it easy to create PC application software for editing or reproducing the above-mentioned program files.

As shown in FIG. 30, the program file 10002 designates programmed reproduction of three media objects 10001. As can be seen here, although a plurality of media objects are recorded under different parent directory, it is possible to designate programmed reproduction.

Another feature of semiconductor media and disc media is addition of data, which leads to easy extension of function.

JP 2000-57745A or JP 2001-160269A discloses a recording/reproduction apparatus that employs a bitstream file 10010, which is AV data, and an information file 10011 for managing it, as shown in FIG. 31. By adding new data (manufacturer information item 10012) to the information file 10011, a new function can be added to the recording/reproduction apparatus.

However, in order to achieve programmed reproduction of program files having the above-described structure, additional hardware and software resources are required for a recording or reproduction apparatus or the like that executes the programmed reproduction.

Therefore, the programmed reproduction may not be achieved by a recording/reproduction apparatus with limited hardware and software resources.

Therefore, it is conceived that simple recording and reproduction of media objects are provided as basic functions for all recording/reproduction apparatuses. In this case, the above-described programmed reproduction function is placed as an extended function. Some apparatuses can execute it, while the other apparatuses cannot execute it.

Even in such a case, a single disc medium, such as a DVD or the like, is recorded or reproduced using a plurality of recording/reproduction apparatuses.

Therefore, when information on a disc medium is manipulated (revision, deletion or the like of a media object) in an apparatus that does not support an extended function, such as programmed reproduction, an inconsistency occurs between information about media objects and information about program files.

When trying to read a disc medium in such an inconsistent state is tried to read using a recording/reproduction apparatus that supports programmed reproduction, there is no media object that should be referenced in a program file, so that the apparatus may malfunction, or in the worst case, the operation of the apparatus comes to a halt.

To avoid such disadvantages, a recording/reproduction apparatus that supports a certain extended function needs to check the consistency of all data relating to the extended function before using the extended function. However, when the amount of the data is large (e.g., a very large number of program files), it takes a long time to check the data, which is disadvantageous to the user.

Also in the technology that data for an extended function is added to the information file as described in JP 2000-57745A and JP 2001-160269A, the size of the information file is inevitably increased.

The basic portion of the information file is required for all recording/reproduction apparatuses. A portion of the information file relating to an extended function is data that is required only for an apparatus that supports the extended function, and is data that is unnecessary for apparatuses that do not support the extended function. In the latter case, a hardware resource is wasted.

### DISCLOSURE OF INVENTION

The present invention is provided to solve the above-described problems. An object of the present invention is to provide a recording apparatus and a recording method with which addition of data for an extended function can be efficiently performed, and when an apparatus that does not support an extended function edits or deletes a media object, an inconsistency between data can be suppressed to the minimum, so that an appropriate data processing method can be determined; a recording medium recorded using the recording apparatus or the recording method; and a reproduction apparatus and a reproduction method for reproducing the recording medium.

To achieve the above-described object, a recording apparatus according to the present invention comprises a recording section for recording information onto a recording medium, a file system processing section for managing the information as a file using file system information having a directory hierarchy structure capable of being referenced using a path name, a contents management information processing section for managing the directory and the file using contents management information, and an extension information processing section for managing extension information with respect to the directory and the file. The contents management information includes media object management information for referencing the directory and the file using object reference information obtained by converting the path name, and extended object management information for managing the extension information. The directory and the file are associated with the extension information via the object reference information.

In the recording apparatus of the present invention, preferably, the extended object management information includes consistency state management information for managing a state of the directory and the file with the extension information corresponding thereto, and when an operation is performed with respect to the directory and the file, the extension information of a type that can be processed is updated, the extension information of a type that cannot be processed is not updated, and the consistency state management information is updated depending on a state of the consistency of the directory and the file with the extension information.

In the recording apparatus of the present invention, preferably, the consistency state management information is provided for each media object management information, and the consistency state management information includes, for each extension information, at least information indicating the presence or absence of reference relationship from the extension information to the directory and the file, and information indicating whether or not the consistency of the directory and the file with the extension information corresponding thereto is assured.

In the recording apparatus of the present invention, preferably, the contents management information includes first update date-and-time information, the extension information includes second update date-and-time information, and when the media object management information is updated, the first update date-and-time information is updated, the same value of that of the first update date-and-time information is set to the second update date-and-time information of the extension information of a type that can be processed, and the second update date-and-time information of the extension information of a type that cannot be processed is not updated.

A first reproduction apparatus according to the present invention for reproducing information from a recording medium recorded using the above-described recording apparatus, comprises a reproduction section for reproducing the information from the recording medium, a file system processing section for processing the file system information, an extension information processing section for processing the extension information, and a contents management information processing section for processing the contents management information. When processing the extension information corresponding to the directory and the file, the extension information processing section determines a procedure for processing the extension information according to a value set in the consistency state management information.

A second reproduction apparatus according to the present invention for reproducing information from a recording medium recorded using the above-described recording apparatus, comprises a reproduction section for reproducing the information from the recording medium, a file system processing section for processing the file system information, an extension information processing section for processing the extension information, and a contents management information processing section for processing the contents management information. When processing the extension information corresponding to the directory and the file, the extension information processing section determines a procedure for processing the extension information according to whether or not the first update date-and-time information matches the second update date-and-time information.

With the above-described feature, addition of data for an extended function can be performed efficiently, and when an apparatus that does not support an extended function edits or deletes a media object, an inconsistency between data can be suppressed to the minimum, so that an appropriate data processing method can be determined.

According to another aspect of the present invention, a recording method is provided. The recording method comprises recording contents information as a file onto a recording medium using file system information having a directory hierarchy structure capable of being referenced using a path name, recording contents management information for managing the directory and the file onto the recording medium, and recording extension information with respect to the directory and the file onto the recording medium. The contents management information includes media object management information for referencing the directory and the file using object reference information obtained by converting the path name, and extended object management information for managing the extension information. The recording method comprises associating the directory and the file with the extension information via the object reference information.

According to still another aspect of the present invention, a reproduction method is provided for reproducing information from a recording medium. A first reproduction method includes reproducing the information from the recording medium, processing the file system information, processing the extension information, and processing the contents management information, and is characterized in that the step of processing the extension information includes determining a procedure for processing the extension information according to a value set in the consistency state management information before processing the extension information corresponding to the directory and the file. A second reproduction method includes reproducing the information from the recording medium, processing the file system information, processing the extension information, and processing the contents management information, and the step of processing the extension information includes determining a procedure for processing the extension information according to whether or not the first update date-and-time information matches the second update date-and-time information before processing the extension information corresponding to the directory and the file.

According to still another aspect of the present invention, a recording medium is provided. The recording medium is a recording medium recording information, recorded with file system information for managing the information as a directory hierarchy structure capable of being referenced using a path name, contents management information for managing the directory and the file, and extension information with respect to the directory and the file. The contents management information includes media object management information for referencing the directory and the file using object reference information obtained by converting the path name, and extended object management information for managing the extension information. The directory and the file are associated with the extension information via the object reference information.

According to still another aspect of the present invention, in a recording apparatus for recording information onto a recording medium, a program is provided for controlling a recording operation of the recording apparatus. The program comprises an instruction for causing the recording apparatus to record contents information as a file onto a recording medium using file system information having a directory hierarchy structure capable of being referenced using a path name, recording contents management information for managing the directory and the file onto the recording medium, and recording extension information with respect to the directory and the file onto the recording medium. The contents management information includes media object management information for referencing the directory and the file using object reference information obtained by converting the path name, and extended object management information for managing the extension information. The program further comprises an instruction for causing the recording apparatus to execute association of the directory and the file with the extension information via the object reference information.

According to still another aspect of the present invention, in a reproduction apparatus for reproducing information from a recording medium, a program is provided for controlling a reproduction operation of the reproduction apparatus. The program comprises an instruction for causing the reproduction apparatus to execute reproducing the information from the recording medium, processing the file system information, processing the extension information, and processing the contents management information. The program comprises an instruction for causing the reproduction apparatus to execute, in the step of processing the extension information, determination of a procedure for processing the extension information according to a value set in the consistency state management information before processing the extension information corresponding to the directory and the file.

According to still another aspect of the present invention, in a reproduction apparatus for reproducing information from a recording medium, a program is provided for controlling a reproduction operation of the reproduction apparatus, the program comprising an instruction for causing the reproduction apparatus to execute reproducing the information from the recording medium, processing the file system information, processing the extension information, and processing the contents management information. The program comprises an instruction for causing the reproduction apparatus to execute, in the step of processing the extension information, determination of a procedure for processing the extension information according to whether or not the first update date-and-time information matches the second update date-and-time information before processing the extension information corresponding to the directory and the file.

According to still another aspect of the present invention, a program providing medium (program product) recording the above-described program is provided.

According to still another aspect of the present invention, a data structure recorded on a recording medium is provided. The data structure comprises file system information for managing contents information recorded on the recording medium as a directory hierarchy structure capable of being referenced using a path name, contents management information for managing the directory and the file, and extension information with respect to the directory and the file. The contents management information includes media object management information for referencing the directory and the file using object reference information obtained by converting the path name, and extended object management information for managing the extension information. The directory and the file are associated with the extension information via the object reference information.

### BRIEF DESCRIPTION OF DRAWINGS

FIG. 1 is a diagram illustrating an outer appearance of a recording/reproducing apparatus according to Embodiment 1 of the present invention, and interfaces between the recording/reproduction apparatus and associated apparatuses.

FIG. 2 is a block diagram showing a schematic configuration of a drive device 110 incorporated in the recording/reproducing apparatus of Embodiment 1 of the present invention and its vicinity.

FIG. 3 is a block diagram showing an exemplary configuration of the recording/reproducing apparatus according to Embodiment 1 of the present invention.

FIG. 4 is a block diagram showing another exemplary configuration of the recording/reproducing apparatus according to Embodiment 1 of the present invention.

FIG. 5 is a block diagram showing still another exemplary configuration of the recording/reproducing apparatus according to Embodiment 1 of the present invention.

FIG. 6 is a block diagram showing still another exemplary configuration of the recording/reproducing apparatus according to Embodiment 1 of the present invention.

FIG. 7A is a diagram showing a recording area of a recordable disc medium 100. FIG. 7B is a diagram illustrating an arrangement in a horizontal direction of a lead-in area, a lead-out area, and a data area, which are arranged on concentric circles in FIG. 7A. FIG. 7C is a diagram showing a logical data space of the disc medium 100 composed of logical sectors.

FIG. 8 is a diagram showing a hierarchical structure of directories and files recorded on the disc medium 100.

FIG. 9A is a diagram illustrating a data structure for managing a directory hierarchy in the UDF specification. FIG. 9B is a diagram illustrating an allocation of the data structure for managing a directory hierarchy in the UDF specification in a partition space.

FIG. 10A is a diagram illustrating a data structure of a file set descriptor (FSD) defined in the UDF specification. FIG. 10B is a diagram illustrating a data structure of long_ad defined in the UDF specification. FIG. 10C is a diagram illustrating a data structure of ADImpUse defined in the UDF specification.

FIG. 11A is a diagram illustrating a data structure of an extended file entry defined in the UDF specification. FIG. 11B is a diagram illustrating a data structure of an Allocation Descriptor defined in the UDF specification. FIG. 11C is a diagram illustrating a data structure of a file identifier descriptor (FID) defined in the UDF specification.

FIG. 12A is a diagram showing a data structure of an Implementation Use Extended Attribute defined in the UDF specification. FIG. 12B is a diagram showing a data structure of an extended attribute stored in Implementation Use 2100.

FIG. 13A is a diagram showing an address space on the disc medium 100. FIG. 13B is a diagram showing a state when AV data can be continuously reproduced by supplying data accumulated in a track buffer to a decoder.

FIG. 14 is a diagram showing a hierarchical structure of data recorded on the disk medium 100, and a system control section 104 for processing the data and an internal structure thereof.

FIG. 15A is a diagram illustrating a data structure of a media object manager 320 in the recording/reproduction apparatus of Embodiment 1 of the present invention. FIG. 15B is a diagram illustrating a data structure of extended object management information (EO_INFO) 720 included in the recording/reproduction apparatus of Embodiment 1 of the present invention. FIG. 15C is a diagram illustrating a value set in an attribute flag 724.

FIG. 16A is a diagram illustrating a data structure of object management information (MO_INFO) 740 in the recording/reproduction apparatus of Embodiment 1 of the present invention. FIG. 16B is a diagram illustrating a value set in an MoType 741. FIG. 16C is a diagram illustrating a conversion rule when a value is set to an OBJ_ID type field.

FIG. 17A is a diagram illustrating a data structure of the program manager 330 in the recording/reproduction apparatus of Embodiment 1 of the present invention. FIG. 17B is a diagram illustrating a data structure of program information (PRG_INFO) 820 in the recording/reproduction apparatus of Embodiment 1 of the present invention.

FIG. 18 is a diagram showing a relationship between a directory and a media object, and the MO_INFO 740.

FIG. 19 is a diagram showing a relationship of the program manager 330 with respect to a media object manager 320.

FIG. 20 is a diagram showing a relationship among directories, media objects, and the media object manager 320, in Embodiment 1 of the present invention.

FIG. 21A is a diagram showing exemplary values set in an extended object management information table 710. FIG. 21B is a diagram showing another exemplary values set in the extended object management information table 710.

FIG. 22 is a flowchart showing a process for recording extension information in the recording/reproduction apparatus of Embodiment 1 of the present invention.

FIG. 23 is a flowchart showing a process for managing extension information in the recording/reproduction apparatus of Embodiment 1 of the present invention.

FIG. 24 is a flowchart showing a process for reproducing extension information in the recording/reproduction apparatus of Embodiment 1 of the present invention.

FIG. 25 is a diagram showing a relationship among a directory and a media object, and the media object manager 320 and an extended object in Embodiment 2 of the present invention.

FIG. 26A is a diagram illustrating a data structure of media object management information (MO_INFO) 2000 in the recording/reproduction apparatus according to Embodiment 2 of the present invention. FIG. 26B is a diagram illustrating a data structure of extended object management information (EO_INFO) 2100 in the recording/reproduction apparatus according to Embodiment 2 of the present invention.

FIG. 27A is a diagram illustrating a data structure of media object management information (MO_INFO) 3000 in the recording/reproduction apparatus according to Embodiment 3 of the present invention. FIG. 27B is a diagram illustrating values set in an extended data attribute flag 3100.

FIG. 28 is a flowchart showing management of an extended data attribute flag in the recording/reproduction apparatus of Embodiment 3 of the present invention.

FIG. 29 is a diagram illustrating values set in the extended data attribute flag 3100.

FIG. 30 is a diagram showing a conventional relationship between directories and media objects, and a program file 10002.

FIG. 31 is a diagram showing a conventional relationship between a directory and a bitstream file, and an information file.

### BEST MODE FOR CARRYING OUT THE INVENTION

Hereinafter, a recording apparatus, a recording method, a recording medium recorded by the recording apparatus or the recording method, and a reproduction apparatus and a reproduction method according to embodiments of the present invention will be described with reference to the accompanying drawings.

### EMBODIMENT 1

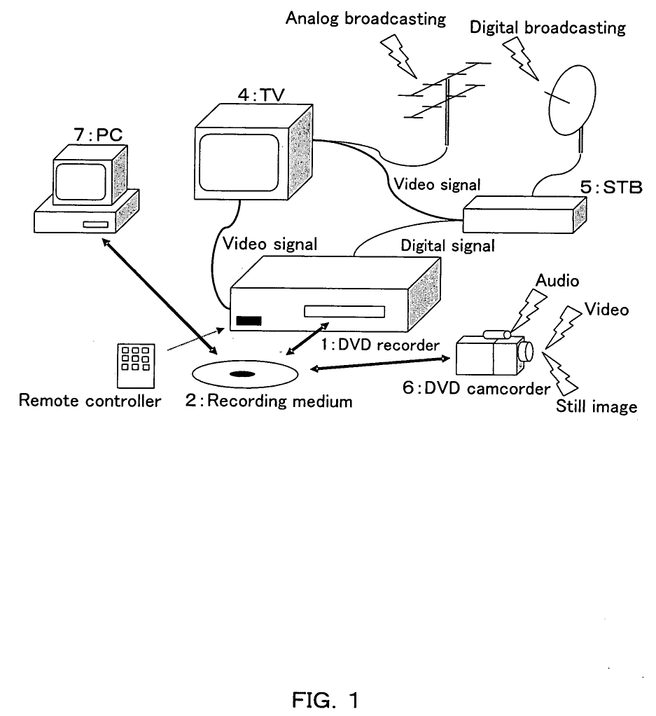

FIG. 1 is a diagram illustrating an outer appearance of a DVD recorder, which is an exemplary recording/reproducing apparatus according to Embodiment 1 of the present invention, and interfaces between the DVD recorder and associated apparatuses. As shown in FIG. 1, a DVD disc 2 as a disc medium that is a recording medium is loaded into the DVD recorder 1 as a recording/reproduction apparatus according to one embodiment of the present invention, whereby video information or the like is recorded/reproduced. The DVD recorder 1 is generally operated using a remote controller 3 or a switch (not shown) on the apparatus.

Video information that is input to the DVD recorder 1 includes both an analog signal and a digital signal. There is analog broadcasting for the analog signal, and digital broadcasting for the digital signal. Generally, in the case of analog broadcasting, a signal is received and demodulated by a receiver built in a television apparatus 4, and is input to the DVD recorder 1 as an analog video signal of the NTSC format or the like.

In the case of digital broadcasting, a digital signal is demodulated by a set-top box (STB) 5 that is a receiver, and is input and recorded in the DVD recorder 1.

Video information recorded on the DVD disc 2 is reproduced by the DVD recorder 1 and is output outside. The output signal also includes both an analog signal and a digital signal as does the input signal. The analog output signal is input directly to the television apparatus 4. The digital output signal is input via the STB 5 to the television apparatus 4 after being converted to an analog signal, and is displayed as a video on the television (TV).

Another embodiment of the recording/reproduction apparatus of the present invention is a DVD camcorder 6 that is an apparatus using the DVD disc 2. The DVD camcorder 6 is a combination of a DVD recorder and a camera apparatus having a lens and a CCD. The DVD camcorder 6 encodes and records captured moving image information.

Video information may also be recorded/reproduced onto/from the DVD disc 2 by a PC 7 or the like, instead of the DVD recorder 1 and the DVD camcorder 6. When the DVD disc 2, on which video information is recorded by the PC 7 or the like, is loaded into the DVD recorder, the DVD disc 2 is reproduced by the DVD recorder.

Video information transmitted via the above-mentioned analog broadcasting or digital broadcasting typically is accompanied by audio information. The accompanying audio information is recorded/reproduced by the DVD recorder in a manner similar to that of video information.

Video information also may be a still image instead of a moving image. In this case, for example, a still image is recorded with a still picture function of the DVD camcorder 6, or a still image is copied from another recording apparatus (hard disk) to the DVD disc 2 on the PC 7.

As a digital interface between the DVD recorder and an external apparatus, such as the STB 5, there are various interfaces. Examples of such a digital interface include IEEE 1394, ATAPI, SCSI, USB, and the like.

In the foregoing description, an analog (composite) video signal in the NTSC format has been exemplified as a signal between the DVD recorder 1 and the television (TV) 4. A component signal in which a luminance signal and a color-difference signal are transmitted separately may be used.

Furthermore, as a video transmission interface between an AV apparatus and a TV, replacing an analog interface by a digital interface such as a DVI has been studied and developed, and it is necessarily expected that a DVD recorder and a TV are connected to each other via a digital interface.

The disc medium 2 (recording medium) is recorded/reproduced by a plurality of recording/reproduction apparatuses, such as the DVD recorder 1, the DVD camcorder 6 and the like. In this case, these recording apparatuses may be produced by the same manufacturer or different manufacturers.

In order to obtain the recording/reproduction compatibility for various recording/reproduction apparatuses, the recording format and the file format of a recording medium are generally standardized. For example, various unified standards, such as DVD-Video Recording specification and the like, have been established.

Manufacturers for recording/reproduction apparatuses commercialize recording/reproduction apparatuses in compliance with a unified standard, taking convenience for the user into consideration.

Meanwhile, each manufacturer often differentiates its own recording/reproduction apparatus from products of other manufacturers by adding its own extended function. The extended function is not included in the unified standard, and is created by each manufacturer separately. To implement the extended function, hardware, software or a peripheral apparatus, which are not shown in FIG. 1, may be optionally added to the recording/reproduction apparatus. For example, a GPS receiver for obtaining positional information, or the like is added.

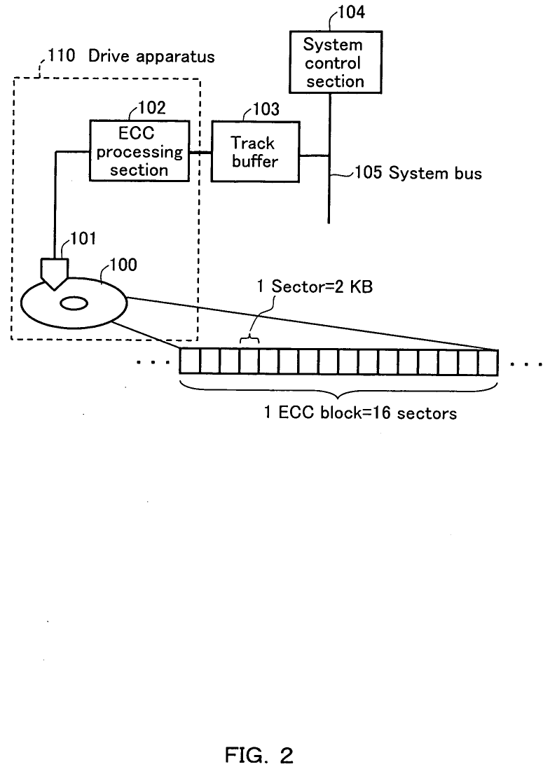

FIG. 2 is a block diagram showing a schematic configuration of a drive device 110 incorporated in the recording/reproducing apparatus of Embodiment 1 of the present invention and its vicinity. In FIG. 2, the drive device 110 includes an optical pickup 101 for recording/reproducing information onto/from a recording medium, and an ECC (Error Correcting Code) processing section 102. For example, the drive device 110 records/reproduces data onto/from a disc medium 100 that is a recording medium, such as a DVD disc.

On the disc medium 100, a sector is a minimum unit for recording. An ECC block is composed of a plurality of sectors. The ECC block is a unit for error correction performed by the ECC processing section 102. The ECC block may also be called an “ECC cluster”.

In the case of a DVD-RAM disc as an example of the disc medium 100, the size of a sector is 2 KB, and an ECC block is composed of 16 sectors. The size of a sector varies depending on the type of the disc medium 100. The size of a sector may be 512 B (bytes), 8 KB, etc.

Alternatively, one ECC block may be composed of one sector. One ECC block may also be composed of 16 sectors, 32 sectors, or the like. In the future, as the capacity of the disc medium is increased, the size of a sector and the number of sectors constituting an ECC block are expected to increase.

The drive device 110 is connected to a track buffer 103. The track buffer 103 is connected via a system bus 105 to a system control section 104 that controls the entire system of the recording/reproducing apparatus.

The track buffer 103 is a buffer for recording AV data onto the disc medium 100 at a variable bit rate (VBR) in order to achieve more efficient recording. Whereas a read/write rate (Va) with respect to the disc medium 100 is fixed, a bit rate (Vb) of AV data varies depending on the complexity of the contents thereof (an image in the case of a video). Thus, the track buffer 103 absorbs a difference between the bit rates.

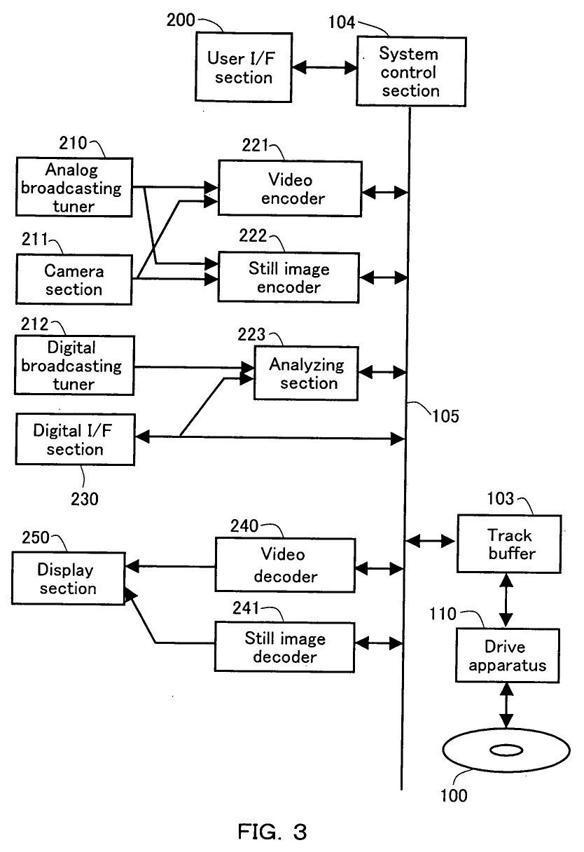

FIG. 3 is a block configuration diagram showing the recording/reproducing apparatus according to Embodiment 1 of the present invention including the drive device 110. As shown in FIG. 3, the recording/reproducing apparatus according to Embodiment 1 of the present invention includes a system control section 104 for managing and controlling the entire system, a user interface (I/F) section 200 for performing display to the user and receiving a request from the user, an analog broadcasting tuner 210 for receiving VHF and UHF signals, a camera section 211 for converting a video to an AV signal, a digital broadcasting tuner 212 for receiving a digital broadcast signal, a video encoder 221 for converting an AV signal input to a digital signal and encoding the digital signal to an MPEG program stream or the like, a still image encoder 222 for encoding an input AV signal to a JPEG stream or the like, an analyzing section 223 for analyzing a digital broadcast MPEG transport stream, a video decoder 240 for decoding MPEG moving image data or the like, a still image decoder 241 for decoding still image data, a display section 250 such as a TV and a loudspeaker, and the like.

The analog broadcasting tuner 210, the camera section 211, the digital broadcasting tuner 212 and the like are connected as input sources of AV data to the video encoder 221, the still image encoder 222, and the analyzing section 223.

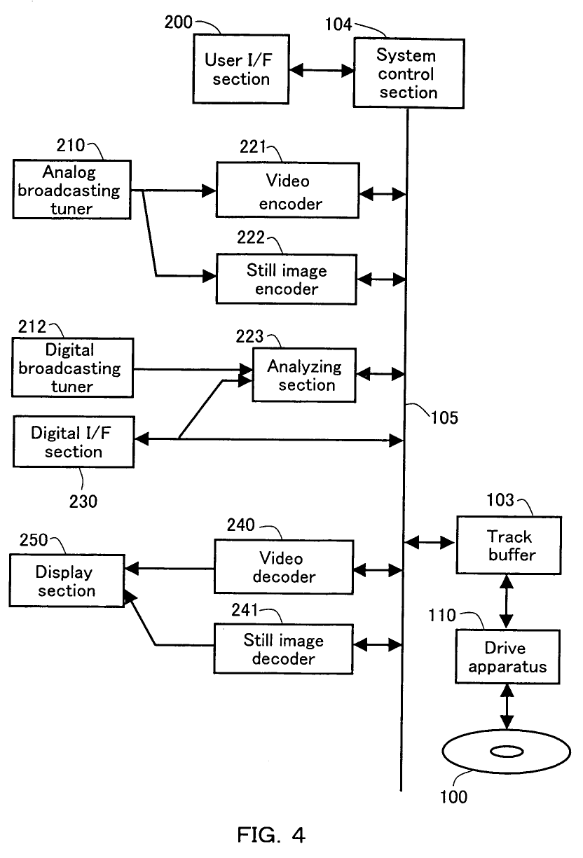

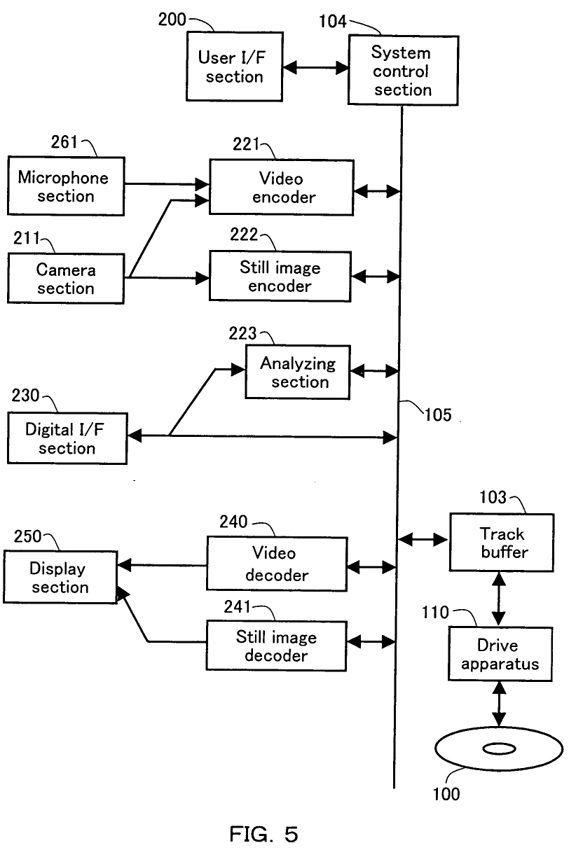

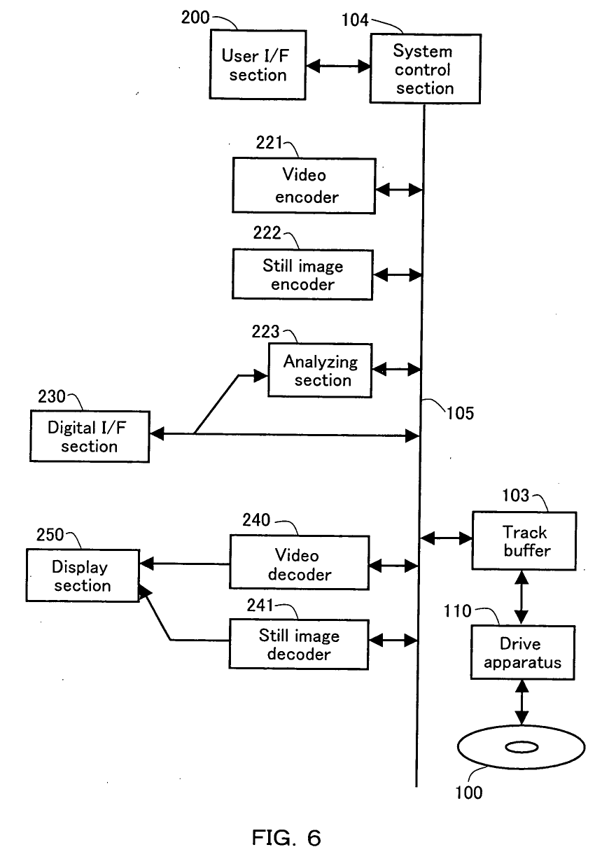

It is not necessary that all of the above-mentioned encoder, tuner, and camera section are provided simultaneously. Only the ones required for the purpose of use of the recording/reproducing apparatus need to be provided. For example, in the case where the recording/reproducing apparatus is a recorder for an optical disc, such as a DVD or the like, the configuration of FIG. 3 may exclude the camera section 211 as shown in FIG. 4. In the case where the recording/reproducing apparatus is a video camera, the configuration of FIG. 3 may exclude the analog broadcasting tuner 210 and the digital broadcasting tuner 212 and may further include a microphone section 261 for collecting sound as shown in FIG. 5. In the case where the recording/reproducing apparatus is a personal computer, the configuration similar to that shown in FIG. 4 may be used. Alternatively, as shown in FIG. 6, the configuration of FIG. 3 may exclude the analog broadcasting tuner 210, the camera section 211, and the digital broadcasting tuner 212.

As shown in FIG. 2, the recording/reproducing apparatus of FIG. 3 further includes the track buffer 103 for temporarily storing write data, and the drive device 110 for writing data onto the disc medium 100.

The recording/reproducing apparatus may also include a digital interface (I/F) section 230 that is an interface for outputting data to an external apparatus using a communication means, such as IEEE 1394, USB or the like.

A detailed operation of the recording/reproducing apparatus according to Embodiment 1 of the present invention will be described elsewhere below.

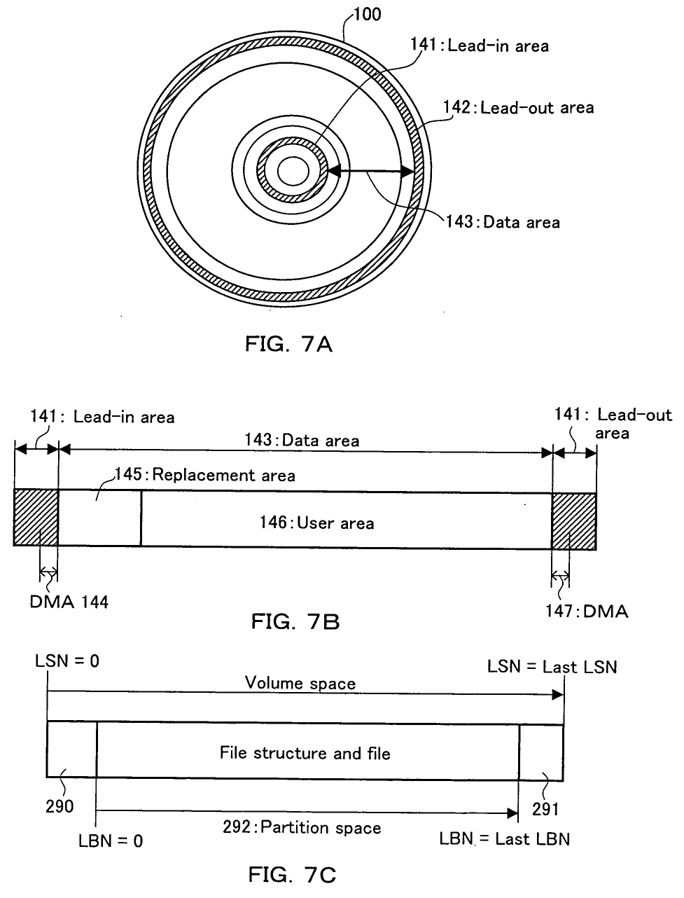

FIG. 7 is a diagram showing an outer appearance and a physical structure of the disc medium 100 that can be recorded using the recording/reproducing apparatus according to Embodiment 1 of the present invention. For example, a disc medium such as a DVD-RAM is loaded into the recording/reproducing apparatus while being accommodated in a cartridge for the purpose of protecting a recording surface. The recording surface may be protected by another technique, and if acceptable, the disk medium may be loaded directly into the recording/reproducing apparatus without being accommodated in a cartridge.

FIG. 7A is a diagram showing an example of a recording area of the recordable disc medium 100. In the example of FIG. 7A, a lead-in area 141 is placed on an innermost periphery, a lead-out area 142 is placed on an outermost periphery, and a data area 143 is placed between the lead-in area and the lead-out area. In the lead-in area 141, a reference signal required for stabilizing a servo when the optical pick-up 101 accesses the disc medium 100, an identification signal for distinguishing the disc medium 100 from others, and the like are recorded. In the lead-out area 142, a reference signal and the like similar to those in the lead-in area 141 are recorded. The data area 143 is divided into sectors that are minimum access units.

FIG. 7B is a diagram illustrating an arrangement in a horizontal direction of the lead-in area 141, the lead-out area 142, and the data area 143, which are arranged as concentric circles in FIG. 7A.

The lead-in area 141 and the lead-out area 142 have Defect Management Areas (DMAs) 144, 147. The defect management area is an area that stores positional information indicating the position of a defective sector, and replacement positional information indicating in which replacement area (described elsewhere below) a replacement sector for a defective sector is present.

The data area 143 has a replacement area 145 and a user area 146. The replacement area 145 is used as a replacement sector to replace a defective sector, if any. The user area 146 is a recording area that can be used by a file system. Some disc media may have no replacement area, depending on the type of the disc medium. In this case, as required, replacement of a defective sector may be performed in a file system, such as UDF (described elsewhere below) or the like.

In order to access each sector in the data area 143, the sectors are generally assigned Physical Sector Numbers (PSNs) successively from the inner periphery. A sector that is managed using PSN is called a “physical sector”.

Further, among the physical sectors of the user area, only sectors used for data recording are assigned continuous Logical Sector Numbers (LSNs) successively from the inner periphery. A sector managed by LSN is called a “logical sector”.

FIG. 7C is a diagram showing a logical data space composed of logical sectors in the user area 146 of FIG. 7B. The logical data space is called a “volume space”, and user data is recorded therein. In the volume space, recorded data is managed by the file system.

In disk media such as a DVD-RAM and the like, the file system is called “UDF”, and those that comply with ECMA 167 and ISO 13346 standards are generally used.

A partition space 292 of the UDF is assigned Logical Block Numbers (LBNs) in data access units, whereby data is allocated and managed.

For the purpose of data allocation, a group of sectors contiguously allocated in the partition space 292 are managed in units called “extent”. A group of associated extents are managed as a file.

Structures called a “file entry (FE)” and an “extended file entry (EFE)” that are information control blocks (ICBs) for managing an extent and a file that is a group of extents, a file identifier descriptor (FID) that is information for managing a group of files as a directory, and the like are recorded in a partition space within a volume space.

Volume structure information 290 for managing a partition space or the like (and its backup 291) is recorded at leading and trailing ends of a volume region.

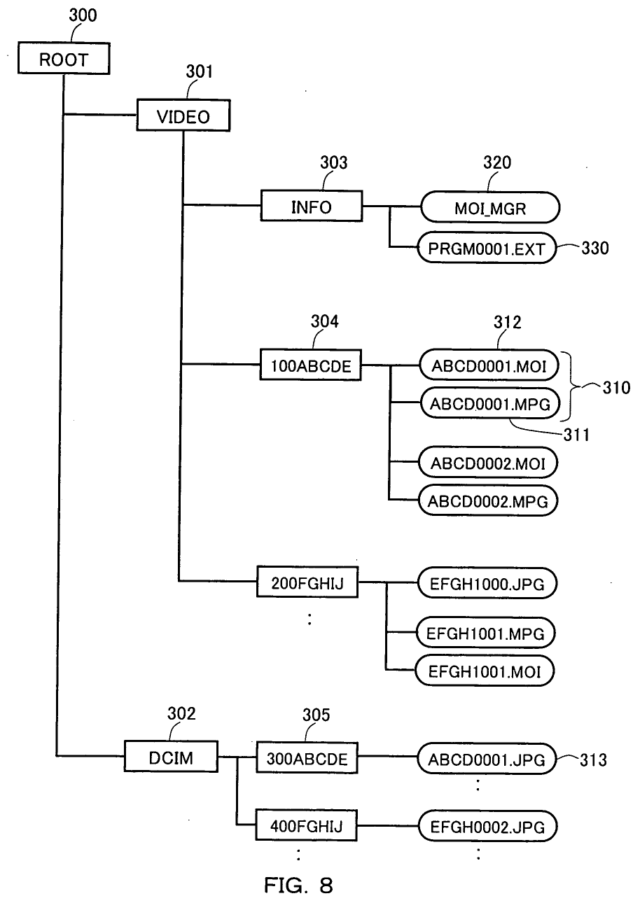

FIG. 8 is a diagram showing an example of a hierarchical structure of directories and files in the disc medium 100 recorded by the recording/reproducing apparatus according to Embodiment 1 of the present invention. As shown in FIG. 8, hierarchical subdirectories (301 to 305, etc.) are present under a ROOT directory 300. Under these subdirectories, various media objects (e.g., 310 to 313, etc.) that are files including moving image data and still image data, a media object manager 320 (file name: MOI_MGR) that is a file for managing each media object, a program manager 330 (file name: PRGM0001.EXT) for grouping a plurality of media objects and managing a reproducing order and classification information, and the like, are stored.

Here, the program manager 330 is a type of extended object that stores extension information, and is, for example, recorded and reproduced by a recording/reproduction apparatus that supports the programmed reproduction function.

It should be noted that, in the embodiment of the present invention, the structure and function of the media object manager 320 are of a type of unified standard, so that the performance of the media object manager 320 is guaranteed for recording/reproduction using all recording/reproduction apparatuses of the present invention.

Extension information refers to various information required for a manufacturer to independently implement an extended function that is not included in a unified standard. Extension information is stored in a file called an “extended object” and is recorded on the disc medium 100. The above-described programmed reproduction function is an example of the extended function.

In Embodiment 1, a directory hierarchy and file name of each media object including AV data to be recorded and reproduced are in accordance with the DCF standard described elsewhere below and a format similar thereto in the following description. The naming rule of directory hierarchies and file names is not limited to this. Other naming rules may be used.

Among media objects, moving image objects including moving image data of MPEG2 or the like are recorded as moving image files in accordance with a naming rule such that first four letters are an arbitrary combination of letters and the following nnnn is a decimal number (e.g., ABCDnnnn.MPG). A moving image file includes AV data compressed using the MPEG2 scheme, the MPEG4 scheme, or the like, and is recorded as a file in the form of a program stream (PS), a transport stream (TS) or the like.

Attribute information about each moving image file is recorded in an attribute information file (file name: ABCDnnnn.MOI). For each moving image file, the attribute information file has identification information, a recording date, a representative image (thumbnail picture) of moving image data, access map information for converting a time of reproduction of the moving image data to a logical address on the disc medium 100 and management information thereof, and the like. The possession of the access map information allows conversion between a time axis of the moving image data and a data (bit sequence) axis, whereby random access can be performed using the time axis of the moving image data as a reference.

The attribute information file may be in conformity with, for example, the QuickTime file format (Apple Computer, Inc.). According to the QuickTime file format, the attribute information is called a “movie resource”. Similarly, the access map information is called a “Sample Table”.

A moving image object is composed of an attribute information file and one or more moving image files, which are associated with each other via a file name. Specifically, an attribute information file and a moving image file are associated with each other using the file name excluding an extension thereof as follows. For example, in a moving image object 310, the file names of a moving image file 311 and an attribute information file 312 have the same portion, i.e., “ABCD0001”, whereby two files are associated with each other.

The method of associating an attribute information file with a moving image file is not limited to this. Other methods may be used. For example, an attribute information file may hold link information to a moving image file, such as a path name to the moving image file or the like, or may hold a correspondence between the two files as table information. It should be noted that a moving image object may include other files in addition to an attribute information file and one or more moving image files. Further, the attribute information file and the moving image file may be integrated into a single file and a moving image object may be composed of the single file.

Among media objects, a still image object includes still image data of JPEG or the like. In a still image object, each piece of still image information is recorded as a still image file (file name: ABCDnnnn.JPG) or the like. The still image file is image data compressed using the JPEG scheme or the like, which is recorded as a file in, for example, the DCF format or the Exif format.

The above-described media object is recorded in accordance with the DCF standard or a similar directory structure. Specifically, a DCF image root directory 302 (directory name: DCIM) is present under the ROOT directory 300. A DCF directory 305 (directory name: 300ABCDE) for storing a still image file is present under the DCF image root directory 302. A DCF basic file 313 (e.g., file name: ABCD0001.JPG), which is a type of still image object, is stored under the DCF directory 305.

Further, a VIDEO image root directory 301 (directory name: VIDEO) is present under the ROOT directory 300. A VIDEO directory 304 (e.g., directory name: 100ABCDE) for mainly storing a moving image object is present under the VIDEO image root directory 301. The attribute information file 312 (a file having an extension MOI) and the moving image file 311 (a file having an extension MPG), which constitute the moving image object 310, are stored under the VIDEO directory 304.

It should be noted that an AV file in other file formats, such as an audio file compressed using AC-3, AAC or the like, a non-compressed audio file, a Motion JPEG file, a DCF extended image file defined according to the DCF standard, a DCF thumbnail file, a PNG file or the like, may be recorded as a media object.

Contents management information for managing recorded media objects are recorded as a media object manager file 320 under a management data directory 303 (directory name: INFO).

An extended object for adding extension information to a media object is also recorded under the management data directory 303. In FIG. 8, the program manager file 330 is recorded as an exemplary extended object. It should be noted that the recording locations of the media object manager file 320 and the extended object are not limited to being under the management data directory 303, and may be under, for example, the VIDEO image root directory 301 or the like. Structures of the media object manager file 320 and the program manager file 330 will be described elsewhere below.

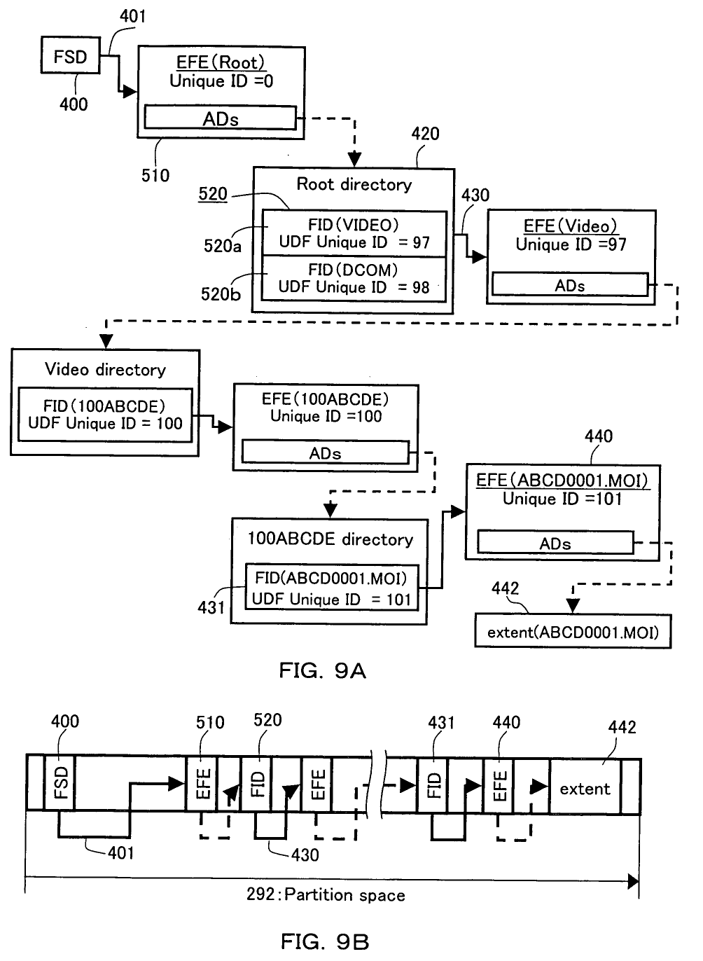

A structure of an UDF file system for use in the recording/reproduction apparatus according to Embodiment 1 of the present invention will be described with reference to FIGS. 9, 10 and 11. In the UDF file system, data is managed as a file on a disc medium.

FIG. 9 is a diagram showing a data structure for managing a directory hierarchy in the UDF file system. It should be noted that FIG. 9 corresponds to the directory hierarchy structure of FIG. 8, indicating only file system information concerning the ROOT directory 300 to the attribute information file 312. Similar information about other directories and files will not be explained for the sake of brevity.

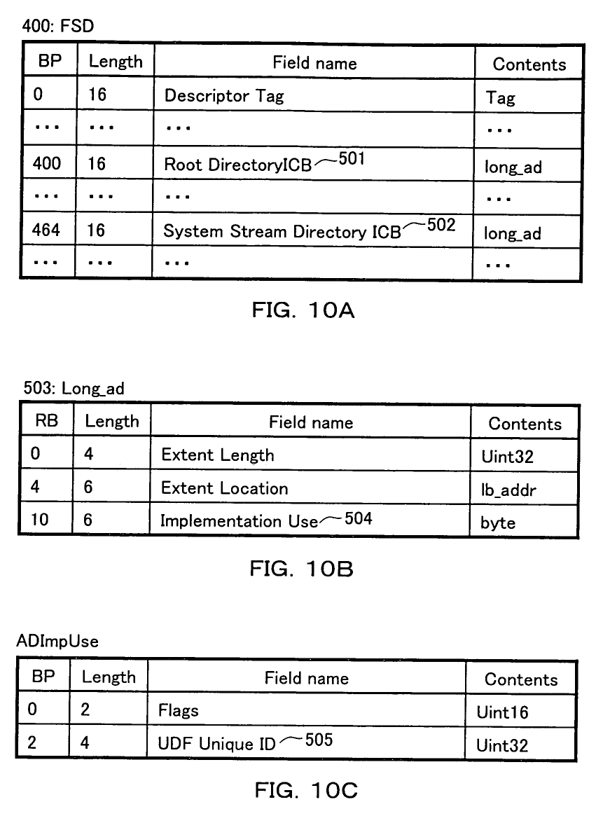

The starting point of the directory hierarchy structure is a File Set Descriptor (FSD) 400. The FSD 400 has a data structure shown in FIG. 10A. The FSD 400 holds reference information 401 (a recording location on the disc medium 100) with respect to an extended file entry (EFE) 510 as a value of Root Directory ICB 501. Further, data called a “Named Stream” can be referenced from a System Stream Directory ICB 502 in the FSD 400.

The Root Directory ICB 501 and the System Stream Directory ICB 502 each have a structure called “long_ad” 503 shown in FIG. 10B. The long_ad 503 holds a length (Extent Length) and a location (Extent Location) of a referenced extent. Further, an Implementation Use 504 holds a value called an “UDF UniqueID” 505 in the ADImpUse format shown in FIG. 10C.

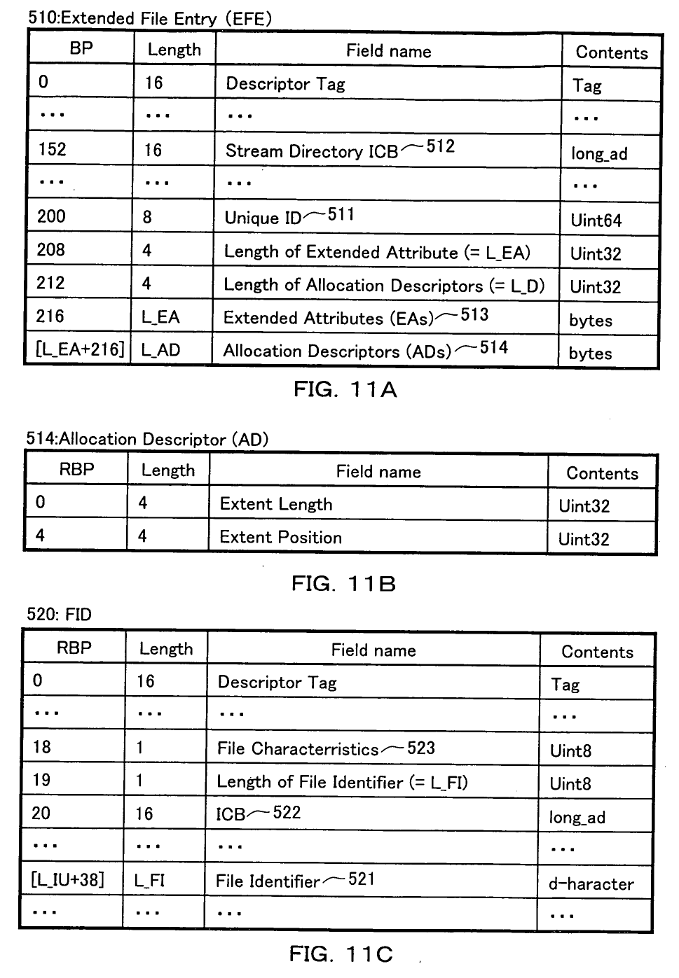

The EFE 510 has a structure shown in FIG. 11A. The EFE 510 is a structure for managing a collection of extents constituting each directory or file recorded on the disc medium 100. The EFE 510 includes a structure called an “allocation descriptor (AD)” 514 shown in FIG. 11B in order to manage the recording location and data length of each extent on the disc medium 100. Each directory or file is composed of a plurality of extents, and therefore, the EFE 510 includes a plurality of ADs 514.

As shown in FIG. 11A, the EFE 510 further includes a Descriptor Tag that indicates a data type, a UniqueID 511 in which a unique ID value that is the only value is set for each directory or file on the disc medium 100, a Stream Directory ICB 512 in which an extended attribute can be set for each EFE 510, Extended Attributes (EAs) 513, and the like.

The EAs 513 is an area for storing an extended attribute defined in the UDF file system, and can be used optionally for extended attribute data defined in the ECMA167 standard or the like, or various application systems or the like. In the EAs 513, there is a field called an “Attribute Type” or an “Attribute Subtype”. By setting an appropriate value in the field, the type of data included in the extended attribute can be identified. Particular Attribute Type and Attribute Subtype values and a data structure corresponding thereto are defined in the ECMA167 standard or the like.

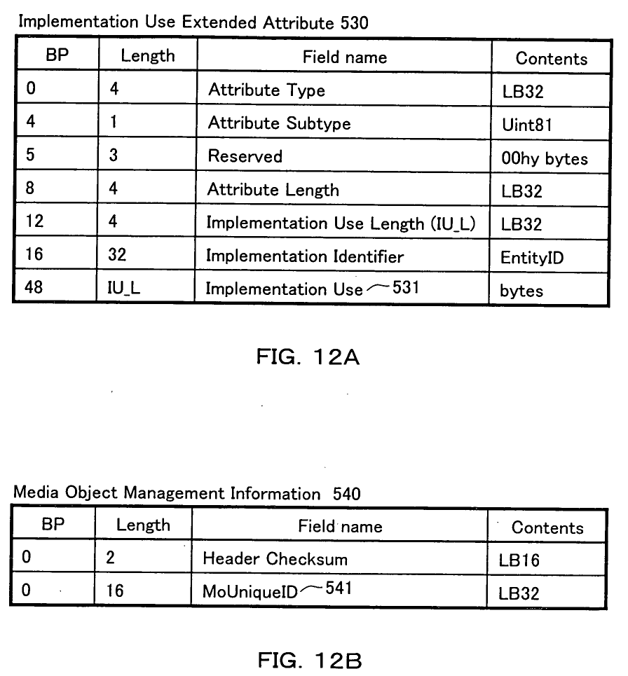

FIG. 12A shows a structure called an “Implementation Use Extended Attribute” 530, which is a type of extended attribute data included in the EAs 513 and can be used in any application system.

When an application system uses the Implementation Use Extended Attribute 530, an extended attribute in the Implementation Use Extended Attribute 530 to be used by the application system can be identified by setting appropriate values to the Attribute Type, Attribute Subtype and Implementation Identifier fields.

An actual value of the extended attribute is stored in an Implementation Use 531, which is a variable-length field having a data length indicated by an Implementation Use Length (IU_L). A data structure of the extended attribute stored in the Implementation Use 531 is determined for each application that uses the extended attribute.

In Embodiment 1, FIG. 12B shows a structure of a Media Object Management Information 540 as exemplary data of the extended attribute stored in the Implementation Use 531. The Media Object Management Information 540 is provided with a field called a “Mo (Media Object) UniquelD” 541. An example of the use of this field will be described elsewhere below.

An extent 420 (see FIG. 9A), which includes directory data, such as the ROOT directory 300 or the like, is composed of a File identifier descriptor (FID) 520 holding the file name of each directory or file. When a subdirectory or a file is present under a certain directory, the FID 520 is held for each directory or file.

For example, according to FIG. 8, the VIDEO image root directory 301 and the DCIM image root directory 302 are present under the ROOT directory 300. As shown in FIG. 9A, the extent 420 of the ROOT directory 300 holds FIDs 421 and 422.

The FID 520 has a structure shown in FIG. 11C. The FID 520 holds the name (file identifier) of each directory or file managed in the UDF as a File Identifier 521. The FID 520 also holds, as an ICB 522, reference information (e.g., 430 in FIG. 9A) with respect to the EFE 510 that manages actual data of a corresponding directory or file.

In addition, the FID 520 includes a Descriptor Tag representing a data type, a Length of File Identifier representing a data length of the File Identifier 521, and the like.

Thereafter, by similarly holding a reference relationship between the EFE 510 and the FID 520, a directory hierarchy structure is managed, and by following the reference relationship sequentially, an extent that is actual data of an arbitrary directory or file can be accessed.

Regarding files, a collection of extents is managed by the EFE 510. In the case of FIG. 9, an extent collection 442 constitutes a file, which corresponds to the attribute information file 312 in FIG. 8.

The above-mentioned FSD 400, EFE 510, and FID 520 are allocated in a partition space. FIG. 9B is a diagram illustrating an allocation of the data structure of FIG. 9A in a partition space. In FIGS. 9A and 9B, the same data is referenced with the same reference numeral.

The extent 442 is accessed by accessing data sequentially, e.g., sequentially from the FSD 400, the EFE 510, the FID 520, . . . , and the EFE 440.

In order to refer to a particular directory or file in a file system having the above-mentioned hierarchical structure, a path name can be used. The path name is expressed, for example, as “/VIDEO/100ABCDE/ABCD0001.MOI” with respect to the extent 442 (file name: ABCD0001.MOI) of FIG. 9. Here, the ROOT directory 300 and a path delimiter are represented by “/”.

Thus, the path name describes names of directories (information stored in the File Identifier 521) present in a path from the ROOT directory 300 to a directory or file of interest through a directory hierarchy, in a series, while delimiting a plurality of directory names with a path delimiter. By utilizing the path name, any arbitrary directory or file managed on a file system can be referenced.

Next, an operation of the recording/reproducing apparatus of Embodiment 1 for recording information onto the disk medium 100 will be described.

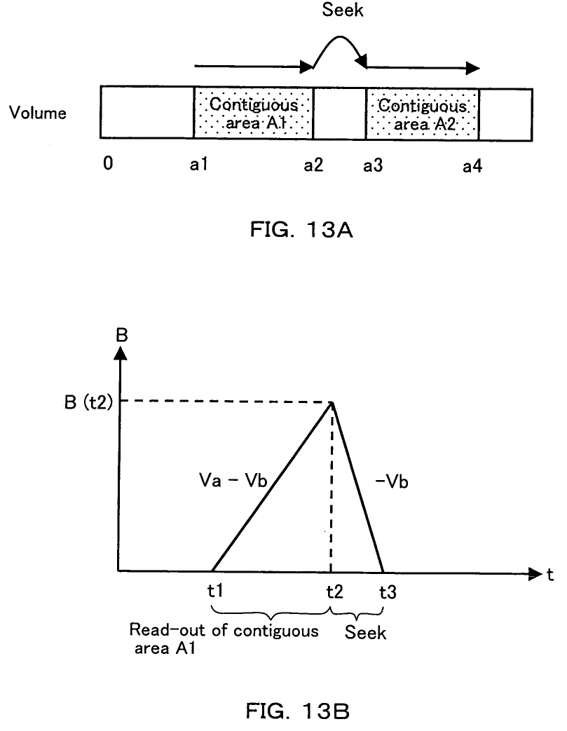

Firstly, the distributed allocation of AV data on the disk medium 100 will be described with reference to FIG. 13. Specifically, by efficiently using the track buffer 103 in the system shown in FIG. 2, AV data can be provided in a distributed manner.

FIG. 13A is a diagram showing an address space on the disk medium 100. In FIG. 13A, it is assumed that an address value is 0 at a left end, and increases to the rightward. Furthermore, “0” and a1 to a4 indicate address values at their respective positions.

As shown in FIG. 13A, when AV data is recorded separately in a contiguous area A1 of [a1, a2] and a contiguous area A2 of [a3, a4], AV data can be reproduced continuously by supplying data accumulated in the track buffer 103 to the video decoder 240 while the optical pickup 101 is performing a seek operation from a2 to a3.

FIG. 13B shows a state of the amount of data accumulated in the track buffer 103 at this time. AV data that is started to be read at the position a1 is input to the track buffer 103 from time t1, while data is started to be output from the track buffer 103. Therefore, data is accumulated in the track buffer 103 by a rate difference (Va−Vb) between an input rate (Va) to the track buffer 103 and an output rate (Vb) from the track buffer 103. This state is continued until the optical pickup 101 reaches a2, that is, until time t2.

Assuming that the amount of data accumulated in the track buffer 103 during the above-described period is B(t2), the amount of data B(t2) accumulated in the track buffer 103 needs to be consumed and continued to be supplied to the video decoder 240 during a period from time t2 to time t3 when reading of data is started at the position a3.

In other words, if the data amount ([a1, a2]) to be read before seeking is kept in a predetermined amount or more, AV data can be supplied continuously even in the case where seeking occurs.

The size of a contiguous area to which AV data can be continuously supplied is obtained when converted to the number of ECC blocks N_ecc by (Expression 1).
N_{—}ecc=Vb×Tj/((N_sec×8×S_size)×(1−Vb/Va)) (Expression 1)
where N_sec is the number of sectors constituting an ECC block, S_size is a sector size, and Tj is seek performance (maximum seek time).

Furthermore, a defective sector may occur in a contiguous area. Considering this case, the size of a contiguous area to which AV data can be continuously supplied is obtained by (Expression 2).
N_{—}ecc=dN_{—}ecc+Vb×(Tj+Ts)/((N_sec×8×S_size)×(1−Vb/Va)) (Expression 2)
where dN_ecc is a size of an acceptable defective sector, and Ts is a time required to skip a defective sector in a contiguous area.

In Embodiment 1, the case where data is read (i.e., reproduced) from the disk medium 100 has been described. However, data is written (i.e., recorded) onto the disk medium 100 in a manner similar to when reproduction is performed.

As described above, on the disk medium 100, when a predetermined amount or more of data is recorded contiguously, it can be reproduced continuously even when AV data is recorded in a distributed manner. For example, in a DVD, such a contiguous area is called a “CDA”. Alternatively, the contiguous area may be called an “AV extent”since it is a special extent for recording AV data.

Next, an operation of the recording/reproducing apparatus according to Embodiment 1 of the present invention will be described with reference to FIG. 3. The recording/reproducing apparatus shown in FIG. 3 starts its operation, for example, when the user I/F section 200 receives a request from the user. The user I/F section 200 transmits the request from the user to the system control section 104. The system control section 104 interprets the request from the user and requests each module to process the request.

Hereinafter, an operation of the recording/reproducing apparatus of Embodiment 1 will be described, for example, where an analog broadcast signal is encoded in accordance with MPEG-2 PS and recorded as a moving image object.

The system control section 104 requests the analog broadcasting tuner 210 to receive an AV signal and the video encoder 221 to encode the AV signal. The video encoder 221 subjects the AV signal transmitted from the analog broadcasting tuner 210 to video-encoding, audio-encoding and system-encoding, and transmits the encoded AV signal to the track buffer 103. After starting encoding, the video encoder 221 transmits information required for creating access map information and the like to the system control section 104 in parallel with the encoding process.

Next, the system control section 104 transmits a recording request to the drive device 110. The drive device 110 retrieves data accumulated in the track buffer 103 and records the data onto the disk medium 100. In this case, the above-mentioned contiguous area CDA is searched for from a recordable area on the disk, and data is recorded into the CDA thus found.

In this case, the search for a recordable area as a CDA is performed based on unallocated space information (e.g., Space Bitmap Descriptor) managed by a file system, such as the UDF.

The end of recording is designated by a stop request from the user. The recording stop request from the user is transmitted through the user I/F section 200 to the system control section 104. The system control section 104 transmits a stop request to the analog broadcasting tuner 210 and the video encoder 221. The video encoder 221 receives the encoding stop request from the system control section 104 and ends an encoding process.

After ending the encoding process, the system control section 104 generates attribute information including access map information, its management information and the like, based on the information received from the video encoder 221.

Next, the system control section 104 requests the drive device 110 to end the recording of data accumulated in the track buffer 103 and to record attribute information. The drive device 110 records the remaining data in the track buffer 103 and the attribute information as an attribute information file, for example, ABCD0001.MOI, which is a file constituting the moving image object of FIG. 9, onto the disk medium 100, and ends recording of the moving image object.

In addition, the system control section 104 optionally generates and updates information of the UDF file system as described in FIGS. 10, 11 and 12. Specifically, the system control section 104 generates the EFE 510 and the FID 520 with respect to files constituting a moving image object, sets required information, and records the EFE 510 and the FID 520 onto the disk medium 100.

In the case where the recording/reproducing apparatus is a camcorder, the recording/reproducing apparatus performs the same process as described above, except that the camera section 211 is used instead of the analog broadcasting tuner 210.

Further, in an operation of recording digital broadcast data as a moving image object, the system control section 104 controls in a manner that records MPEG2 TS data as a moving image object onto the disk medium 100 through the digital broadcasting tuner 212 and the analyzing section 223 without encoding the moving image data. In this case, file system information is also recorded in a manner similar to that described above.

Next, regarding recording of a still image object, an operation of encoding an AV signal transmitted from the camera section 211 using JPEG, and recording the encoded signal, will be described.

The system control section 104 requests the camera section 211 to output an AV signal, and the still image encoder 222 to encode the AV signal. The still image encoder 222 encodes the AV signal transmitted from the camera section 211 using JPEG, and transmits the encoded AV signal to the track buffer 103.

While receiving an instruction from the system control section 104, the drive device 110 records data accumulated in the track buffer 103 onto the disk medium 100. In this case, a recordable area for the data is sought based on unallocated space information managed by a file system, such as the UDF or the like.

When one still image object is recorded, shooting is ended. Alternatively, when an instruction of continuous shooting is issued from a user, shooting is ended based on a stop request from the user, or shooting is ended after a predetermined number of still image objects are recorded. The shooting stop request from the user is transmitted through the user I/F section 200 to the system control section 104, and the system control section 104 transmits a stop request to the camera section 211 and the still image encoder 222.

Further, the system control section 104 also performs a required process with respect to information of the UDF file system. Specifically, the system control section 104 generates the EFE 510, the FID 520 and the like with respect to a file constituting a still image object, sets required information, and thereafter records them onto the disk medium 100.

Each media object recorded on the disk medium 100 with the above-mentioned procedure is registered in the media object manager 320 of FIG. 8, for the purpose of subsequent management. A relationship between each media object and the media object manager 320 will be described elsewhere below. Although the present invention is described using the EFE 510, an FE may be used instead of the EFE 510.

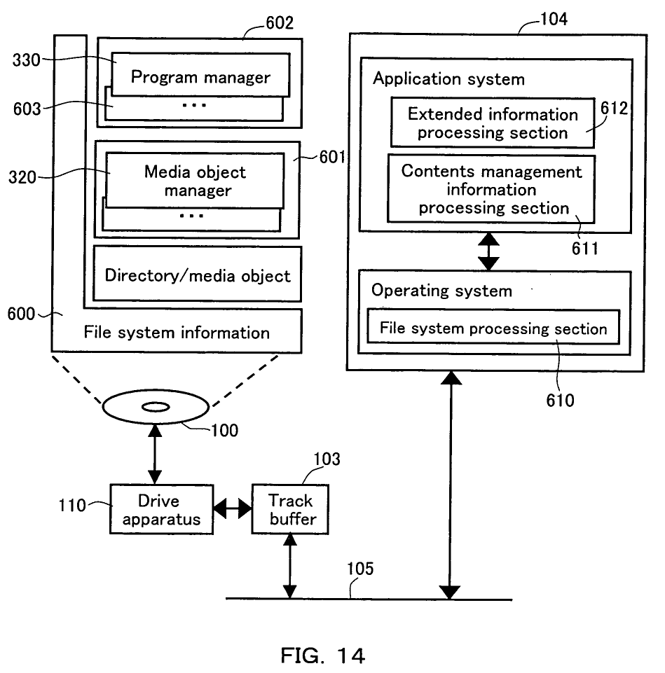

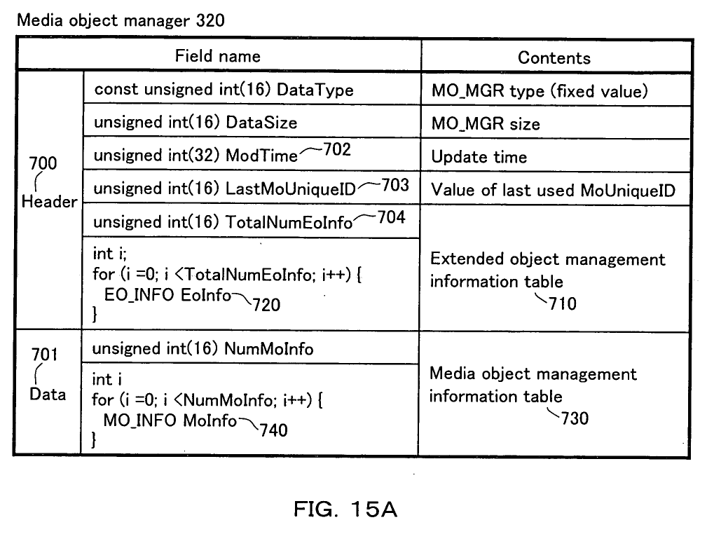

FIG. 14 is a diagram showing an exemplary hierarchical structure of data recorded on the disk medium 100 for use in the recording/reproducing apparatus according to Embodiment 1 of the present invention, and the system control section 104 for processing the data and an internal structure thereof.

File system information 600 is recorded on the disk medium 100. The file system information 600 includes the volume structure information 290 of FIG. 7C, the FSD 400, EFE 510 and FID 520 of FIGS. 10, 11 and 12, the above-mentioned Space Bitmap Descriptor, and the like.

Further, the media object manager 320 for managing a plurality of media objects together is similarly managed as a file, constituting contents management information 601.

Furthermore, an extended object 603 providing a media object to extension information 602 also is managed as a file. The program manager 330 is also an example of an extended object, and is provided in order to classify a plurality of media objects in accordance with the contents, the recording date and time, etc., and perform programmed reproduction in which the user freely sets the order of media objects to be reproduced.

Data to be recorded on the disk medium 100 is operated by the system control section 104 through the system bus 105.

More specifically, the system control section 104 is composed of an operating system (OS) and an application system.

The operating system includes a file system processing section 610 for controlling the file system information 600, a device driver section for controlling hardware (not shown), a memory control section (not shown), and the like, and provides various common functions to the application system through an Application Program Interface (API). Therefore, the application system can be created independently from the details of the hardware and the file system.

The application system performs a control operation for a particular application. In Embodiment 1, for example, as described with reference to FIG. 3, recording/reproduction of a moving image object or a still image object is controlled.

A contents management information processing section 611 in the application system operates the contents management information 601 and the media object manager 320 included therein.

An extension information processing section 612 performs operations with respect to the extension information 602 and the extended object 603 included therein. An operation with respect to the extended object 603 will be described elsewhere below.

The application system may further include sections for displaying AV data, processing a user interface, and the like, as required.

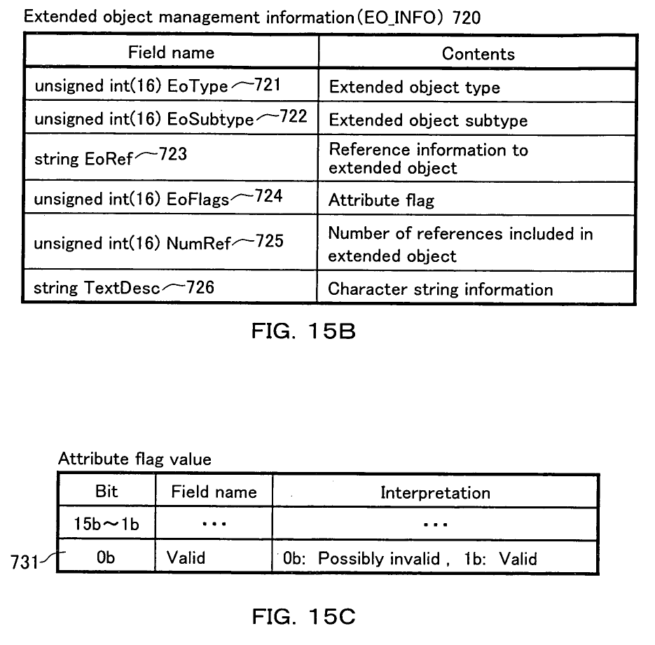

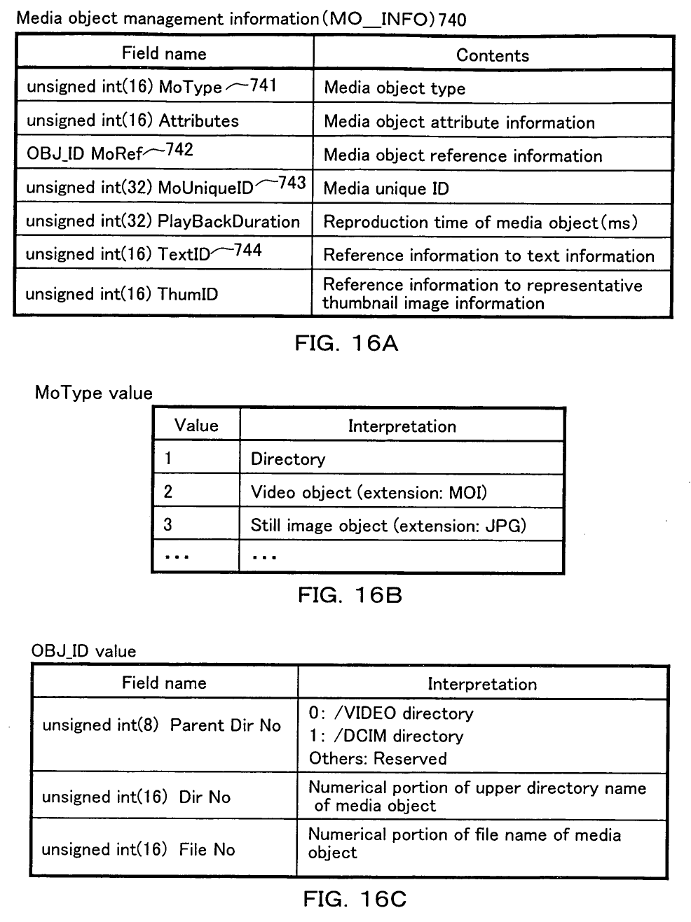

A data structure of the media object manager 320 will be described with reference to FIGS. 15 to 16.

FIG. 15A is a diagram illustrating a data structure of the media object manager 320. As shown in FIG. 15A, the media object manager 320 is composed of a header portion 700 and a data portion 701.

The header portion 700 includes a DataType representing a file type, a DataSize representing a file size, a ModTime 702 representing the date and time of the media object manager 320, and the like. The header portion 700 further includes an extended object management information table 710 for managing the extension information 602. It should be noted that a LastMoUniqueID703 will be described elsewhere below.

The data portion 701 includes a media object management information table 730. The media object management information table 730 is composed of NumMoInfo indicating the number of pieces of media object management information (MO_INFO) 740 in the media object manager 320 and NumMoInfo pieces of MO_INFO 740.

In a field name column of in FIG. 15 and the like, a data type and a field name are described successively. The data type means, for example, the following.

“const” means that a field has a constant. The absence of “const” means that a field has a variable. “unsigned” means that a field has an unsigned value. The absence of “unsigned” means that a field has a signed value. “int( )” means that a field has an integer value having a bit length in parentheses. For example, when the value in parentheses is “16”, the bit length is 16. “string” means character string information.

FIG. 15B shows a data structure of extended object management information (EO_INFO) 720 included in the media object manager 320. The EO_INFO 720 has a data structure for registration/management of an extended object, such as the program manager 330 or the like, and has an EoType 721 and an EoSubType 722 indicating type information for identifying each extended object.

The. EoType 721 and the EoSubType 722 may store, for example, owner information or information about the purpose of use of an extended object as a numerical value or an alphabetical value.

The EO_INFO 720 further includes extended object reference information (EoRef) 723 holding reference information with respect to an extended object as a path name, EoFlags 724 that are attribute flags shown in FIG. 15C, a TextDesc 726 for storing character string information indicating an outline of an extended object, and the like.

FIG. 15C shows an exemplary structure of the EoFlags 724 for storing various information about an extended object indicated by the EO_INFO 720 as flags. In Embodiment 1, 0th bit is used as a Valid field.

When the Valid field has a value of 1b, consistency among the media object manager 320, a media object managed thereby, and an extended object indicated by the EO_INFO 720 is maintained, assuring that information included in the extended object is valid. When the Valid field has a value of 0b, such assurance is not obtained.

FIG. 16A shows a data structure of object management information (MO_INFO) 740 included in the media object manager 320.

The MO_INFO 740 is composed of a MoType 741 indicating the type information of a registered media object, object reference information (MoRef) 742 that is reference information with respect to a media object, a MoUniqueID 743 to which a media unique ID that is the only value in the media object manager 320 is set, and the like.

The media unique ID that is the only value is set as follows. For example, an initial value is set to be 0. The media unique ID value is incremented by one and is assigned every time a media object is newly recorded. At a certain time point, a maximum value of the media unique ID is recorded into the LastMoUniqueID 703. Thus, it is easy to determine a value of the media unique ID to be next assigned (i.e., a value obtained by adding one to the LastMoUniqueID 703) even after suspension of recording.

Alternatively, as described with reference to FIG. 11, the UDF file system sets a UniqueID 511, which is the only one, to each file on the file system. Therefore, the value of a UniqueID 511 can be used as the value of a media unique ID.

It should be noted that, in Embodiment 1, the same value as that set in the MoUniqueID 743 may be set as the MoUniqueID 541 in the EAs 513 of the EFE 510 of FIG. 11A.

In addition, the MO_INFO 740 includes Attributes indicating various types of attribute information, a PlayBackDuration that is a reproduction time of the media object, reference information TextID with respect to text information stored in a place different from that of the MO_INFO 740, reference information ThumID with respect to thumbnail information stored in a place different from that of the MO_INFO 740, and the like.

As shown in FIG. 16B, a value set into the MoType 741 is determined based on the type of a media object referenced.

When the MoType has a value of 1, the type of a media object registered in certain object media information is a directory on a file system. Similarly, when the MoType has a value of 2, the type of a media object is a moving image object (extension: MOI). When the MoType has a value of 3, the type of a media object is a still image object (extension: JPG). Similarly, different MoType values are assigned to media object types.

A value set into the MoRef 742 is determined by converting path name information of a media object to be referenced in accordance with a conversion rule shown in FIG. 16C.

A first field Parent Dir No is determined based on a path name of a parent directory of a media object to be referenced by the MO_INFO 740. Specifically, when the parent directory is the VIDEO image root directory 301, the Parent Dir No is ‘0’. When the parent directory is the DCIM image root directory 302, the Parent Dir No is ‘1’. Other values are not used in Embodiment 1, so that they are defined as reserved values.

Needless to say, values given by the conversion rule may be other combinations of values. For example, the VIDEO image root directory 301 may be assigned ‘1’, the DCIM image root directory 302 may be assigned ‘2’, and other values may be reserved values.

In the next field Dir No, a directory number portion of the media object, which is extracted from the MO_INFO 740, is stored. Here, the directory number refers to a numerical portion of the directory name of a parent directory of the media object.

In the next field File No, a file number of a media object, which is extracted from the MO_INFO 740, is stored. Here, the file number refers to a numerical portion of the file name of the media object.

For example, it is assumed that the path name of a media object is “/VIDEO/100ABCDE/ABCD0001.MOI”. The media object has a “/VIDEO” directory as a parent directory. The Parent Dir No value of OBJ_ID is ‘0’. The numerical portion value of the parent directory name of the media object is ‘100’. The Dir No value of OBJ_ID is “100”. Further, the File No value of OBJ_ID is “0001”, which is the value of a numerical portion extracted from the file name of the media object.

Thus, a value set into the MoRef 742 is 0/100/0001 according to a notation in which Parent Dir No, Dir No, and File No are arranged in this order using “/” as a delimiter. Hereinafter, the value of OBJ_ID will be indicated according to a similar notation, as required.

Even when OBJ_ID is in the above-mentioned format, a media object referenced by the MoRef 742 can be specified in a file system, as long as a naming rule, in which the numerical portion value of the name or the parent directory name of each media object is a unique value (e.g., a naming rule of the DCF standard), is kept and used together with extension information derived from the above-mentioned value of the MoType 741. Such a structure is preferable for the purpose of reducing the amount of data of the MO_INFO 740.

Needless to say, the data structure of OBJ_ID may be in any format as long as the MO_INFO 740 can be uniquely associated with a media object. For example, the path information of a media object may be stored as it is. Specifically, a character string of a full-path name using “/” as a path delimiter, such as “/VIDEO/100ABCDE/ABCD0001.MOI”, may be stored.

Alternatively, an extension of a file may be stored in place of the MoType 740. For example, for the file “/VIDEO/100ABCDE/ABCD0001.MOI”, “MOI” may be stored.

For moving image objects, only an attribute information file (e.g., 312 in FIG. 8) may be registered in object management information. This is because it is possible to know a corresponding moving image file (in this case, 311 in FIG. 8) from an attribute information file based on the association and the like of the file name as described above. Alternatively, conversely, the moving image file may be registered in the object management information. This is because it is possible to know a corresponding attribute information file similarly. Needless to say, both the attribute information file and the moving image file may be registered.

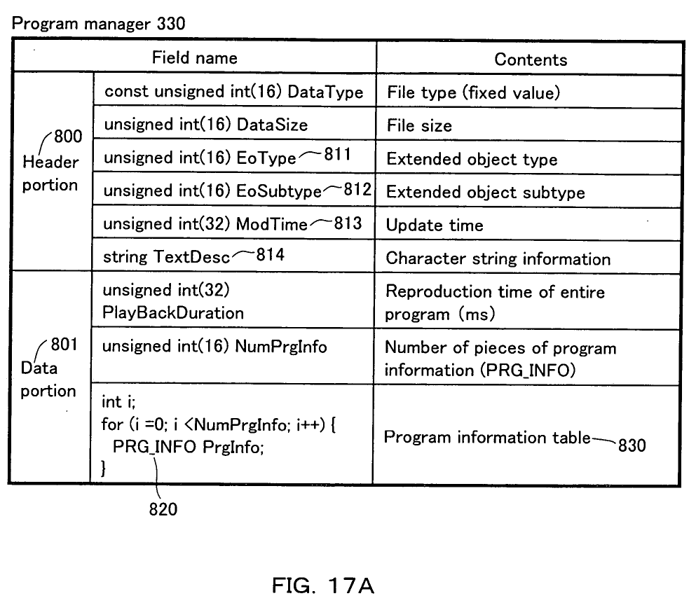

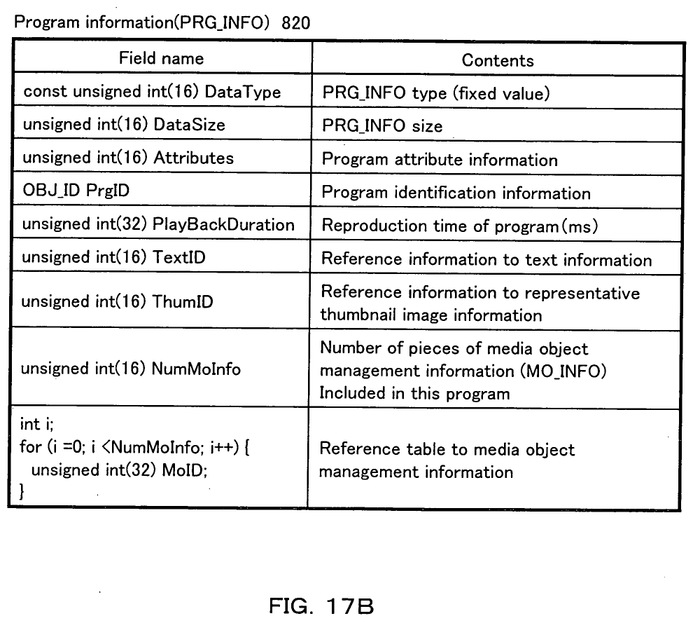

Next, a data structure of the program manager 330, which is an exemplary extended object according to Embodiment 1 of the present invention, will be described below with reference to FIG. 17.

A common structure of extended objects has a header portion 800 and a data portion 801.

The header portion 800 is composed of a DataType representing a file type (a fixed value indicating an extended object is set), a DataSize representing a file size, an EoType 811 and an EoSubType 812 indicating type information of the extended object, a ModTime 813 indicating update time, a TextDesc 814 storing character string information indicating an outline of the extended object, and the like.

In the header portion 800, the type of the extended object is classified based on values of the EoType 811 and the EoSubType 812.

The extended object is referenced from the EO_INFO 720. In this case, values of the EoType 811, the EoSubType 812 and the TextDesc 814 are set into the EoType 721, the EoSubType 722 and the TextDesc 726 of the EO_INFO 720.

The data portion 801 stores extended data specific to each type of extended object and has a data structure varying depending on the values of the EoType 811 and the EoSubType 812.

FIG. 17A shows an example in the case of the program manager 330 that is an extended object for programmed reproduction. The program manager 330 has the following structure as extended data.

The extended data is composed of a PlayBackDuration that is a total of reproduction times of all media objects registered in the program manager 330, a NumPrgInfo indicating the number of pieces of program information (PRG_INFO) 820 included in the program manager 330, and a program information table 830 including NumPrgInfo pieces of PRG_INFO 820.

FIG. 17B shows a data structure of the program information (PRG_INFO) 820 included in the program manager 330. The PRG_INFO 820 is a unit when the MO_INFO 740 is grouped to classify a plurality of media objects recorded on the disc medium 100, or programmed reproduction is performed by reproducing sequentially media objects referenced from the PRG_INFO 820.

As shown in FIG. 17B, the PRG_INFO 820 is composed of a DataType indicating that the PRG_INFO 820 is program information, a DataSize indicating a size of the PRG_INFO 820, Attributes indicating various types of attribute information of a program, a PlayBackDuration that is a reproduction time of the program, a NumMoInfo indicating the number of references with respect to the MO_INFO 740 included in the PRG_INFO 820, and a reference table with respect to the MO_INFO 740 including NumMoInfo pieces of MoIDs, and the like.

In addition, the PRG_INFO 820 may include, for example, reference information Text ID and reference information ThumID with respect to text information and thumbnail information, respectively, which are stored in a place different from the PRG_INFO 820.

With the above-described structure, the program manager 330 (extended object) can be used to group any arbitrary media objects. Therefore, a virtual folder structure can be configured independently from a directory structure on a file system, and media objects can be classified freely. Further, it is possible to achieve a function, such as, for example, programmed reproduction that allows reproduction of media objects in an order of the media objects to be reproduced, which is desired by the user.

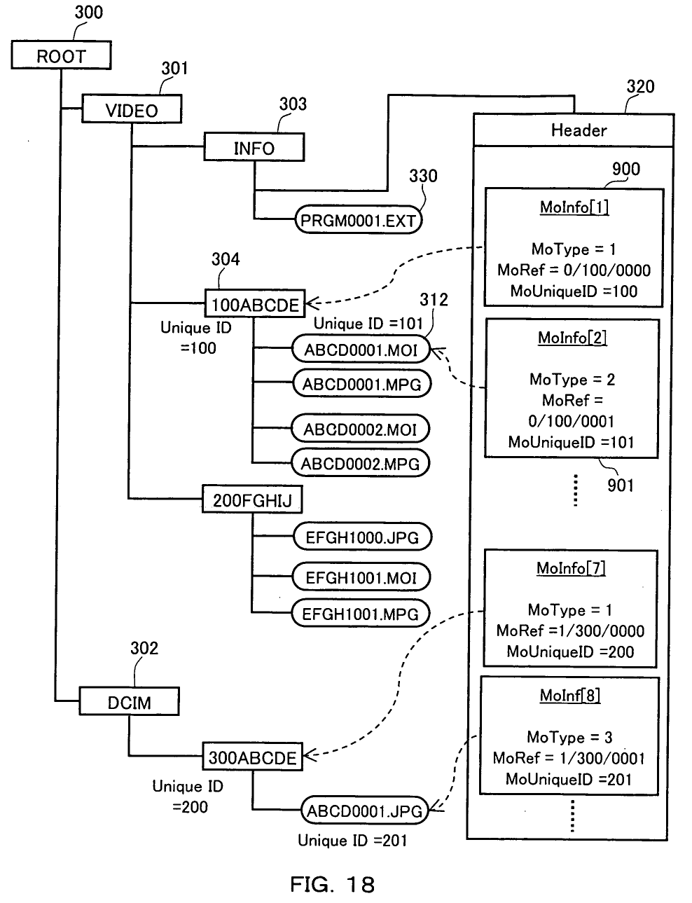

Next, a relationship between directories and media objects managed by a file system and the MO_INFO 740 will be described with reference to FIG. 18.

In the media object manager 320, a plurality of pieces of MO_INFO 740 are included, and a media object is registered in each MO_INFO 740. For example, in MoInfo[1] 900, the directory 304 is registered. In this case, the values of fields of the Molnfo[1] 900 are set as follows.

Firstly, “1” representing a directory is set in the MoType according to FIG. 16B. The MoRef has an entire field value of 0/100/0000, where ‘0’ indicates a parent directory, ‘100’ indicates a directory number, and ‘0000’ indicates a file number, according to FIG. 16C.

The MoUniqueID 743 is set to be ‘100’ that does not overlap the values set in the other MO_INFOs.

Values of fields of MoInfo[2] 901 are set as follows. Firstly, ‘2’ indicating a moving image object is set in the MoType. The MoRef 711 has an entire field value of 0/100/0001, where ‘0’ indicates a parent directory, ‘100’ indicates a directory number, and ‘0001’ indicates a file number. The MoUniquelD is set to be ‘101’, which does not overlap the values set in the other MO_INFOs. Values similarly are set into the other MoInfo's.

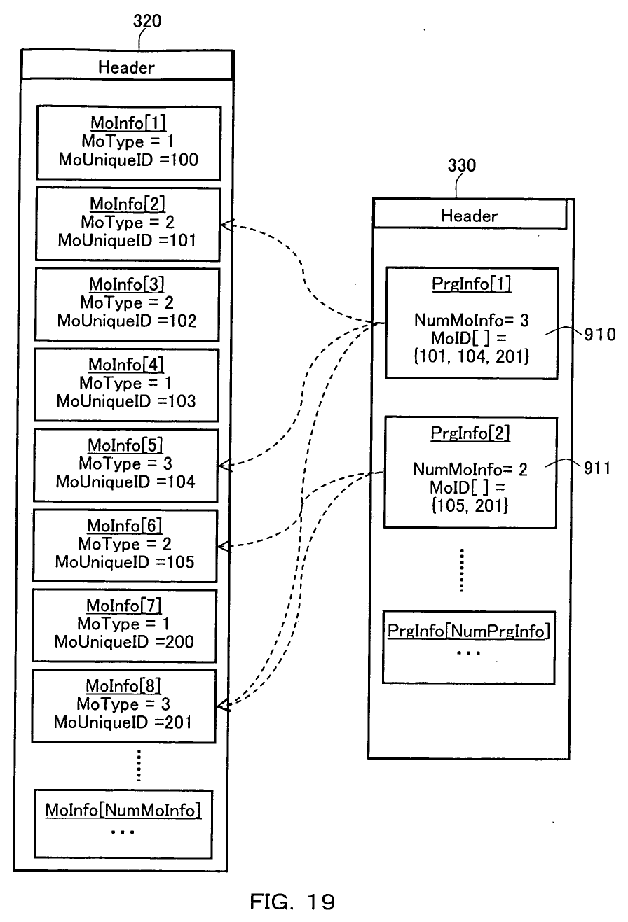

FIG. 19 shows a relationship of the program manager 330 with respect to the media object manager 320. As described above, the program manager 330 includes a plurality of PRG_INFO 820 (Prglnfo[1] 910 . . . ).

Each PRG_INFO 820 holds reference information with respect to the MO_INFO 740 as a media unique ID. Specifically, a value of a media unique ID held in the MoUniqueID 712 of the MO_INFO 740 is used as the reference information.

For example, PrgInfo[1] 910 has a reference to MoInfo[2], MoInfo[5], and MoInfo[8] as indicated by dashed-line arrows in FIG. 19, and thus holds 101, 104 and 201 as values of the table of MoID (MoID[]). Similarly, PrgInfo[2] 911 has a reference to MoInfo[6] and MoInfo[8], and thus holds 105 and 201 as values of MoID[].

In this state, a process for performing programmed reproduction will be described. For example, it is assumed that the start of programmed reproduction by the PrgInfo[1] 910 is designated. The contents management information processing section 611 reads out a value of reference table MoID[] with reference to media object information in the PrgInfo[1] 910. As described above, MoID[] holds, as a media unique ID, reference information with respect to a media object to be subjected to programmed reproduction.

Therefore, in order to perform programmed reproduction, the MO_INFO 740 designating a media unique ID held in the MoID[] is searched for in the media object manager 320. If such a media unique ID is retrieved, a media object referenced by the MO_INFO 740 is reproduced.

By repeating a similar procedure with respect to all media unique IDs held in the MoID[], programmed reproduction is performed.

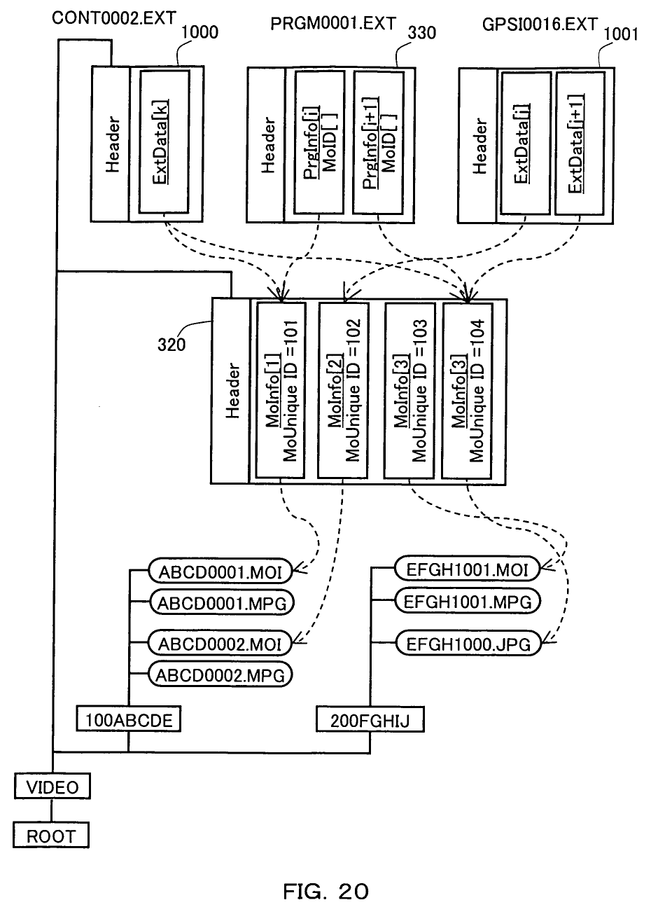

FIG. 20 shows a relationship among directories, media objects, and the media object manager 320, which are managed in a file system, when a plurality of extended objects are present. In this case, extended objects 1000 and 1001 are present, which are different from the program manager 330.

Similar to what has been described with reference to FIG. 19, the extended objects 1000 and 1001 are associated with a media object via the media object manager 320 (e.g., via a media unique ID as with the program manager 330), providing various extension information.

For example, the extended object 1000 is an extended object that holds a value obtained by counting the number of times of reproduction in which each media object has so far been reproduced. The count value is incremented and held in the extended object 1000 every time each media object is reproduced. Thus, by holding the count value as extension information, it is possible to indicate whether or not a certain media object already has been viewed/heard by the user.

Alternatively, the count value of the number of times of reproduction can be used to determine the user's preference of recorded video. For example, when the count value is large, it is determined that the user's favorite video is recorded. Conversely, a media object that has a small count value is determined not to be a favorite. Such information can be used as reference information when an unnecessary media object is deleted, for example, if the empty volume of the recording medium 100 is small.

Further, the extended object 1001 stores GPS information of each media object. Positional information when each media object was recorded is recorded, whereby it subsequently can be used to retrieve and display the media object.

Assuming that the user took commemorative pictures in his/her trip, if GPS information is available, positional information about the destination can be used to easily search a plurality of media objects for one of interest.

It should be noted that data held as an extended object is not limited to the above-described data and may be other data. For example, the data may be camera parameters for each media object (a camera type, the presence or absence of zoom, the presence or absence of flash, etc. when recording), meta data of MPEG7 or the like. Further, in order to differentiate a product of a manufacturer from those of other manufacturers or provides its own convenience to the user, other data may be used to achieve a function, such as the media object manager 320 or the like, which is not included in a unified standard.

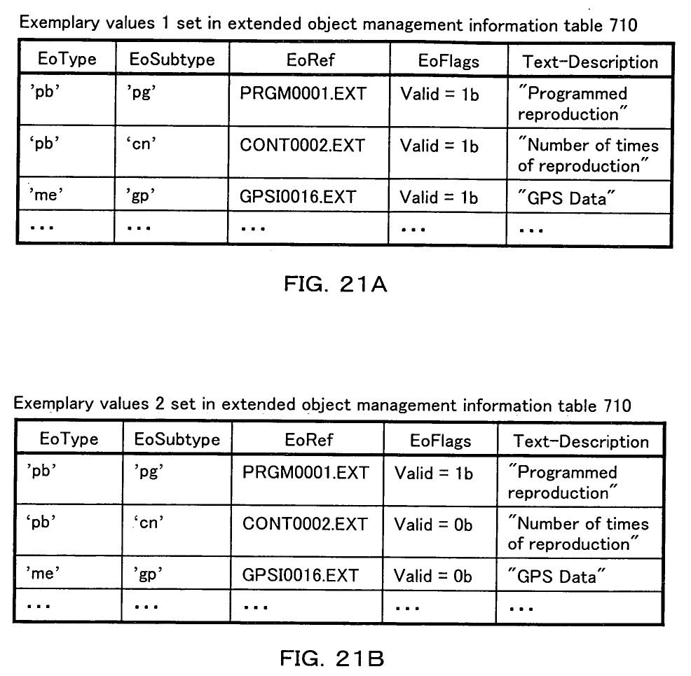

FIG. 21 is a diagram showing exemplary values set in the extended object management information table 710 in the state of FIG. 20.

A row in FIG. 21A corresponds to EO_INFO 720. The EoType and EoSubtype of each EO_INFO are set to be values (here, two-character ASCII codes) for identifying the contents of each extended object. It should be noted that the values of the EoType and EoSubtype are only illustrative, and any other values may be used as long as each extended object can be identified.

As an EoRef, here, the file name of an extended object is stored. It should be noted that a data format when an extended object is referenced may be any other format, and a particular conversion rule, such as a file number or the like, can be utilized as with OBJ_ID used when the MO_INFO 740 references a media object.

Here, assuming that all pieces of information are valid, EoFlags are all set to be Valid=1b. The TextDesc holds contents of information held by each extended object as a simple character string.

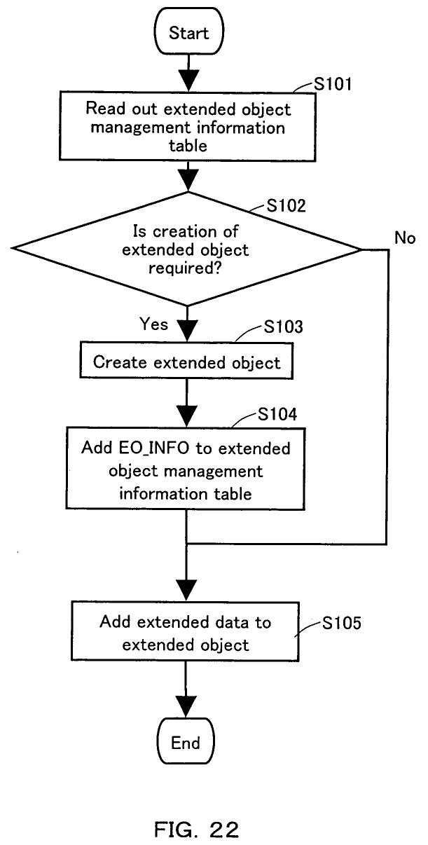

FIG. 22 is a flowchart showing a process for recording a new extended object and extended data in Embodiment 1.

Firstly, the extension information processing section 612 reads out the extended object management information table 710 from the media object manager 320 (step S101).

Next, by examining the value of each EO_INFO 720 in the extended object management information table 710, it is determined whether or not an extended object including extended data to be added is already present (step S102).

When the extended object is not present, the extended object is newly created (step S103) and a corresponding EO_INFO 720 is added to the extended object management information table 710 (step S104). When the extended object is present and after the extended object is newly created, extended data is added to the extended object (step S105).

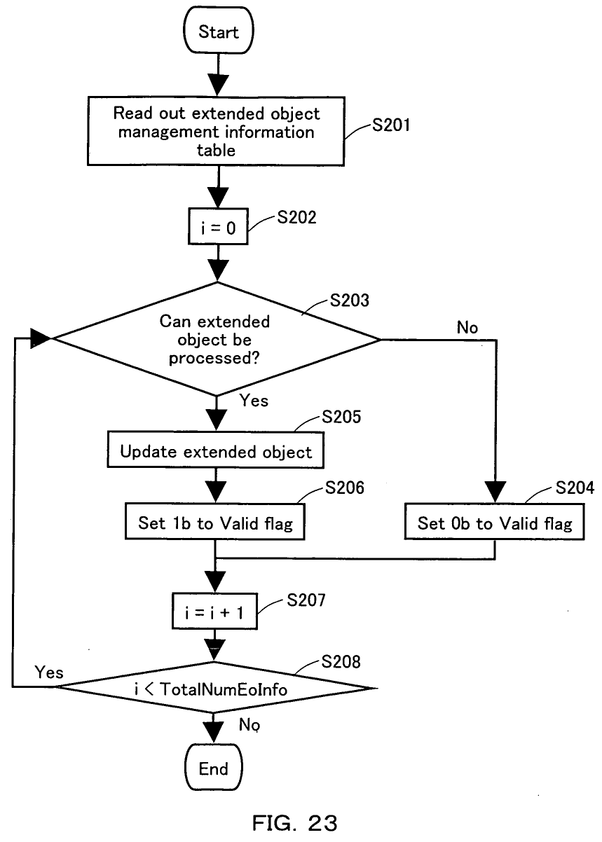

FIG. 23 is a flowchart showing a process performed with respect to the extended object management information table 710 after any operation is performed with respect to the media object and MO_INFO 740, in Embodiment 1. Here, any operation with respect to the media object and MO_INFO 740 refers to, for example, rewrite, edit, delete, and the like for data values in media objects and the MO_INFO 740.

When such an operation is performed, an information inconsistency may occur between a media object and the media object manager 320, and an extended object and extended data.

For example, if a media object referenced by PRG_INFO 820, which is a type of extended data, is deleted, there is no object to be referenced by PRG_INFO 820, and thus a malfunction occurs when programmed reproduction is performed.

The same is true of extended data during a function other than programmed reproduction. A malfunction occurs when a referenced media object or MO_INFO 740 is changed.

To avoid this, in Embodiment 1, when any operation has been performed with respect to a media object and the media object manager 320, the following process is performed.

Firstly, the extension information processing section 612 reads out the extended object management information table 710 from the media object manager 320 (step S201).

In the extended object management information table 710, the EO_INFO 720 is present in a number indicated by a TotalNumEoInfo 704. All the EO_INFO 720 are processed by a loop process from step S202 to step S208.

Firstly, a count value for the loop process is initialized (step S202).

Thereafter, it is determined whether or not a first extended object can be processed (step S203). For the determination, the EoType 721 and the EoSubtype722, and the EoRef 723 can be utilized.

Some recording/reproduction apparatuses may operate only a particular type of extended object. Therefore, if an extended object is found to be incapable of being processed, a Valid flag 731 is set to be 0b (step S204). The Valid flag 731 (0b) indicates that consistency is not assured between the extended object, and the media object and the media object manager 320. Alternatively, if an extended object is found to be capable of being processed, the contents of the extended object are updated (step S205), and the Valid flag 731 is set to be 1b (step S206).

Here, the updating of the contents of an extended object refers to a process for matching the contents of the extended object to a result of the previous operation with respect to a media object and the media object manager 320.

For example, it is assumed that the extended object is the program manager 330, and the operation with respect to a media object and the media object manager 320 is deletion of the media object and the MO_INFO 740 referencing thereto. In this case, the program manager 330 is processed so that the PRG_INFO 820 referencing the MO_INFO 740 is updated and the reference to the deleted MO_INFO 740 is deleted. Other types of extended objects are subjected to updating processes corresponding to the respective extension information.

By performing the update process, consistency can be assured between the extended object, and the media object and the media object manager 320. Therefore, the Valid flag 731 is set to be 1b.

Thereafter, the process is repeated while incrementing the count value, until the count value is equal to the value of the TotalNumEoInfo (steps S207, S208).

FIG. 21B shows exemplary values set in the extended object management information table 710 after completion of the process as shown in FIG. 23.

Here, as an example, exemplary values will be shown, which are set after a process by a recording/reproduction apparatus, in which only programmed reproduction can be processed as an extended object and the other types of extended objects cannot be processed. The Valid flags of the EO_INFO 720 in a second row and thereafter are set to be 0b, indicating a state that the data validity of these extended objects is not assured.

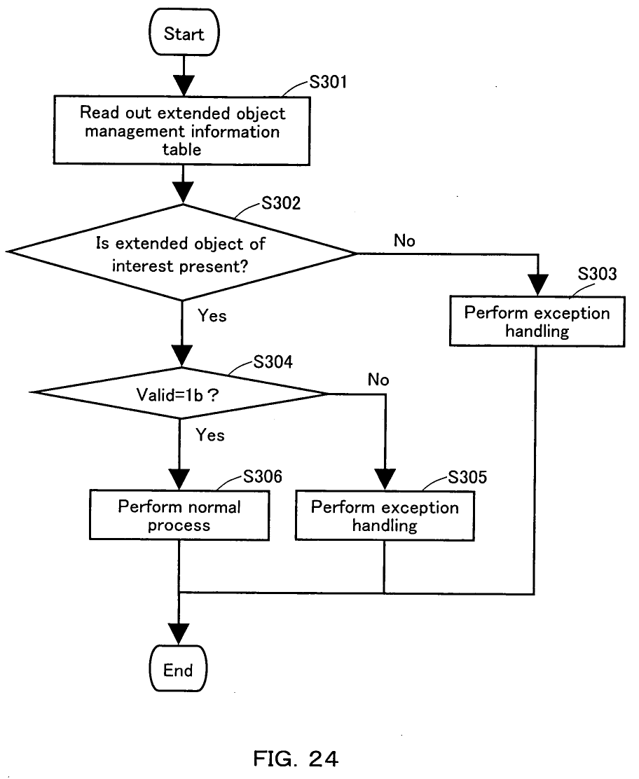

FIG. 24 is a flowchart relating to a process performed when a particular type of extended object is designated and data thereof is utilized, in Embodiment 1.

Firstly, the extension information processing section 612 reads out the extended object management information table 710 from the media object manager 320 (step S301).

Next, the extended object management information table 710 is searched to obtain an EO_INFO 720 that references an extended object of interest (step S302). The extended object of interest can be detected by examining values of the EoType 721 and the EoSubtype 722. Alternatively, the extended object of interest can be detected by referencing the value of the EoRef 723 if a naming rule is previously defined for the path name of an extended object.

If no EO_INFO 720 referencing the extended object of interest is retrieved, exception handling is performed (step S303) and the process of the flowchart is ended. The exception handling refers to, for example, a process of displaying a message informing the user that the desired extended object is not present, a process of newly creating the extended object, or the like.

If an EO_INFO 720 that references the extended object of interest is retrieved, then it is determined whether or not the value of the Valid flag is 1b (step S304).

When the value of the Valid flag is not 1b, exception handling is performed (step S305). In this case, the exception handling refers to, for example, a process of displaying a message informing the user that a inconsistency is present between the desired extended object and the media object manager 320, or forbidding writing with respect to the recording medium 100, a process of updating information within the extended object in order to correct an inconsistency of the extended object and the media object manager 320, or the like.

When the value of the Valid flag is 1b, a normal process is performed with respect to the extended object (step S306). The normal process refers to, for example, programmed reproduction if the extended object is the program manager 330.

Also for other extended objects, operations are performed depending on the respective types, including displaying to the user an extended data associated with a certain media object (e.g., displaying GPS information, or the like).

When exception handling shown in FIG. 24 is performed, by displaying at least a value of the TextDesc 726, it is possible to inform the user what extension information is set.

Thus, extension information can be added without significantly increasing the data volume of the media object manager 320.

This feature is desirable for recording/reproduction apparatuses, such as consumer electronics apparatuses (e.g., a DVD recorder, a DVD camcorder, etc.) that have a limited hardware resource. Further, when a media object is edited or deleted, data inconsistency is minimized even if an extended function that is not supported by a certain recording/reproduction apparatus is present, and an appropriate data processing method can be determined. Thus, it is possible to avoid a malfunction of an apparatus, system stop, a reduction in convenience for the user, and the like.

This feature is desirable when a recording medium is recorded/reproduced using recording/reproduction apparatuses of a plurality of manufacturers, such as DVD recorders, DVD camcorders and the like that use a removable recording medium.

### EMBODIMENT 2

In Embodiment 2, a method for management of an extended object that is different from that of Embodiment 1 will be described. Although the extended object management information table 710 is used to manage an extended object in Embodiment 1, MO_INFO is used to manage each extended object.

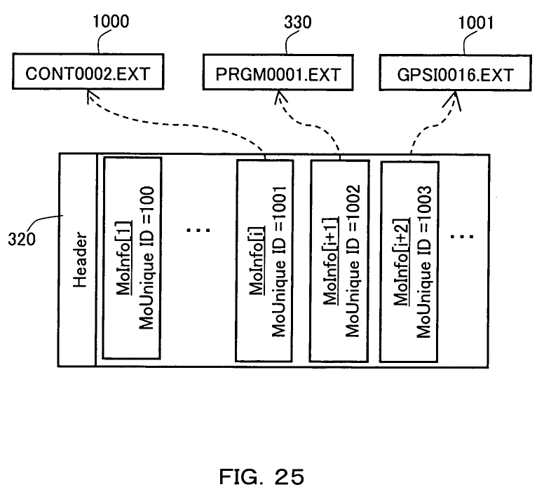

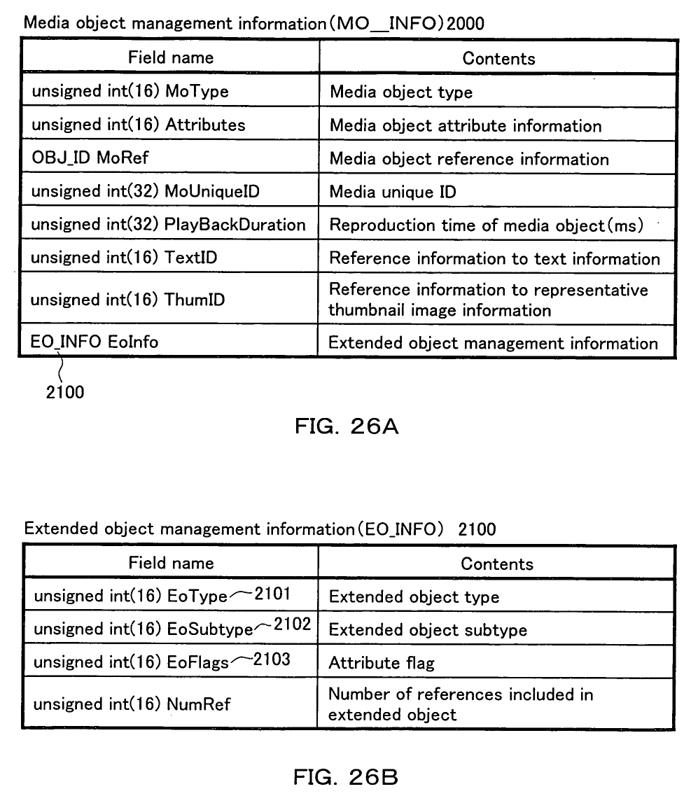

FIG. 25 shows a relationship between an extended object and the MO_INFO in Embodiment 2. Here, MoInfo[i] to Molnfo[i+2], which are MO_INFOs included in the media object manager 320, each reference and manage extended objects 1000, 330 and 1001. It should be noted that the MO_INFO of Embodiment 2 has a structure shown in FIG. 26.

MO_INFO 2000 shown in FIG. 26A is the same as the MO_INFO 740, except that a field EO_INFO 2100 is added.

The EO_INFO 2100 has a structure different from that of the EO_INFO 720, and has a structure shown in FIG. 26B.

The EO_INFO 2100 has the same structure as that of the EO_INFO 720, except for the EoRef 723 and the TextDesc 726, and plays a similar function by using the MoType 741 and the MoRef 742 instead of the EoRef 723, and a TextID 744 instead of the TextDesc 726. Specifically, the MoType 741 and the MoRef 742 are used to reference an extended object, and the TextDesc 726 is used to store character string information with respect to the extended object.

It should be noted that, in order to achieve the above-described function, a value (e.g., “4”) indicating an extended object (extension: EXT) is defined with respect to a value of the MoType 741 of FIG. 16B.

Further, the directory name and file name of an extended object are defined using a naming rule such that unique reference can be achieved using a directory number and a file number in order to perform reference using the MoRef 742.

According to the above-described structure, a media object and an extended object can be managed in a common framework, providing an advantage in implementating apparatuses.

### EMBODIMENT 3

In Embodiment 3, a method for managing different extended objects will be described.

Although the validity of an extended object is managed in the Valid flag 731 of the extended object management information table 710 in Embodiment 1, the validity of each extended object is managed in MO_INFO in Embodiment 3.

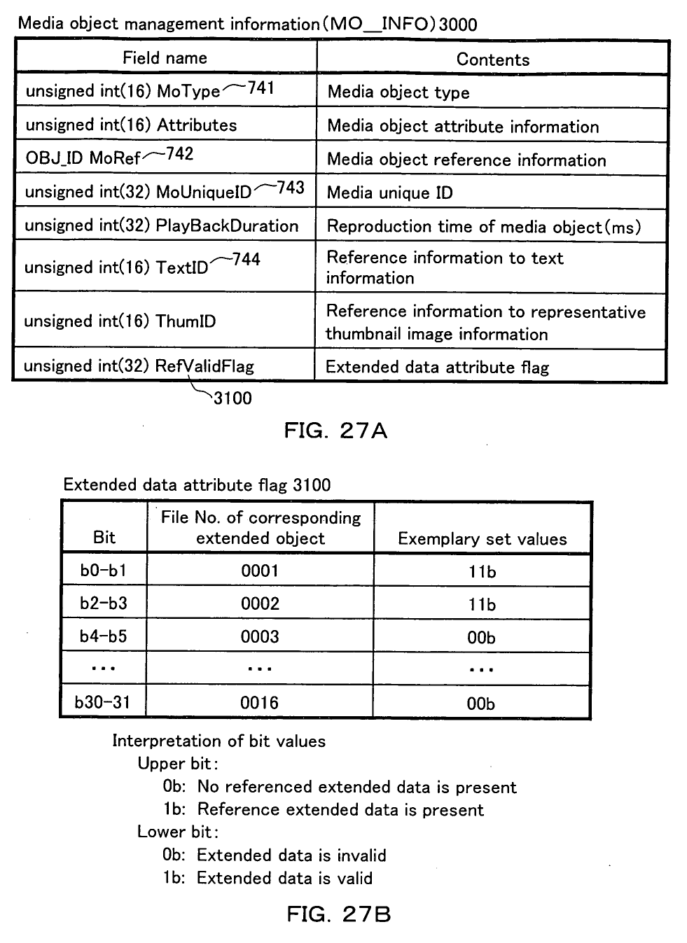

In this case, the MO_INFO, which references/manages a media object, has a data structure shown in FIG. 27.

MO_INFO 3000 shown in FIG. 27A is the same as the MO_INFO 740, except that a field, extended data attribute flag (RefValidFlag) 3100, is added.

The RefValidFlag 3100 holds information shown in FIG. 27B. In the RefValidFlag 3100, two bits correspond to one extended object.

For example, bits 0 to 1 correspond to an extended object having a file number 0001. Similarly, bits 1 to 2 correspond to an extended object having a file number 0002. The same is true of subsequent bits.

Each two bits are interpreted as follows. Specifically, the upper bit indicates whether reference from an extended object to a media object managed by the MO_INFO 3000 is present (1b) or not (0b). The lower bit indicates whether extended data is valid (1b) or invalid (0b) with respect to the media object managed by the MO_INFO 3000.

In other words, the lower bit has the same meaning as that of the Valid flag 731. It should be noted that the lower bit of the RefValidFlag 3100 indicates the validity of extended data in units of the MO_INFO 3000, i.e., extended data can be managed in finer units.

Specifically, for example, when a reference relationship similar to that shown in FIG. 20 is present, a value set in the RefValidFlag 3100 of MoInfo[1] is an “exemplary set value” shown in the rightmost column of FIG. 27B.

Specifically, MoInfo[1] is referenced from a program manager 330, which is an extended object having a file number of 0001, and when it is assumed that the value thereof is valid, bits 0 and 1 are set to be a value of 11b. Similarly, MoInfo[1] is also referenced from an extended object having a file number of 0002, and when it is assumed that the value thereof is valid, bits 2 and 3 are set to be a value of 11b.

An extended object having a file number of 0016 is present. However, MoInfo[1] is not referenced from it, and therefore, bits 30 and 31 are set to be a value of 00b.

In the above-described state, when a media object is subjected to an edit operation or the like as in the process described with reference to FIG. 23, the consistency of the media object and an extended object may no longer be assured.

For example, if a media object referenced from the PRG_INFO 820 (a type of extended data) is edited so that the reproduction time length is changed (e.g., the reproduction time is shortened), a PlayBackDuration (a program reproduction time) differs from an actual time, confusing the user when programmed reproduction is performed.

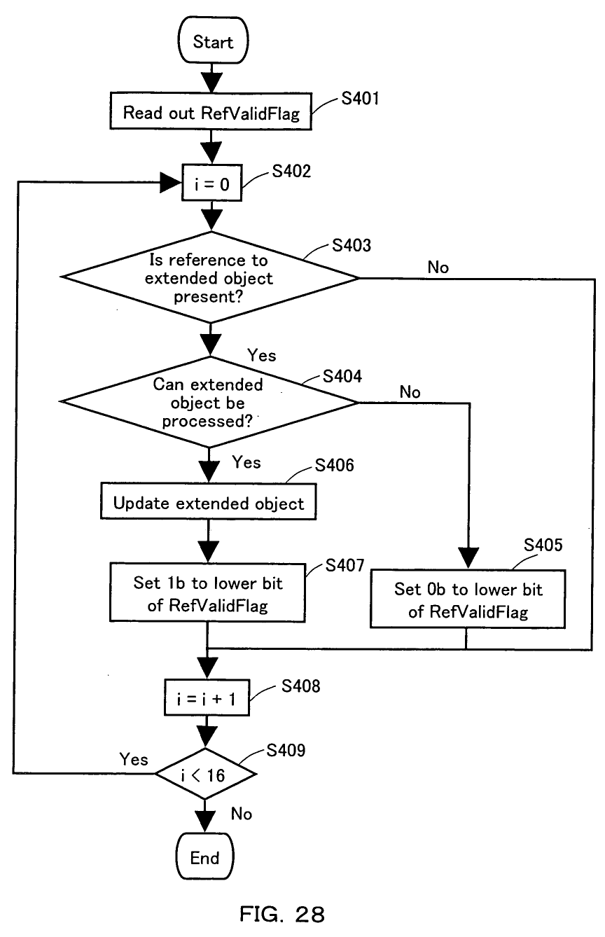

To avoid this, a process shown in FIG. 28 is performed.

Firstly, the extension information processing section 612 reads out the RefValidFlag 3100 from the media object management information 3000 to be edited (step S401).

There is a possibility that extended objects are present in a number corresponding to the field length of the RefValidFlag 3100. Therefore, all the extended objects present are processed using a loop process from step S402 to step S409.

Next, a count value for the loop process is initialized (step S402).

Thereafter, for a first extended object, it is determined whether or not an extended object referencing the media object is present (step S403). The determination is made based on the value of the upper bit of the two bits in the RefValidFlag 3100 corresponding to the extended object. If no reference is present, the process goes to step 408.

If a reference is present, it is determined whether or not the extended object can be processed (step S404).

Some recording/reproduction apparatuses may operate only a particular type of extended object. If it is determined that the extended object cannot be processed, the value of the lower bit of the two bits in the RefValidFlag 3100 corresponding to the extended object is set to be 0b (step S405). Thus, it is indicated that the consistency between the extended object and the media object is not assured.

Conversely, if it is determined that the extended object can be processed, the contents of the extended object is updated (step S406), and the value of the lower bit of the two bits in the RefValidFlag 3100 corresponding to the extended object is set to be 1b (step S407). In this case, updating of the contents of the extended object means, for example, updating of the PlaybackDuration of a program in association with editing of the media object.

Thereafter, the process is repeated for the entire RefValidFlag 3100 while incrementing the count value (steps S408, S409).

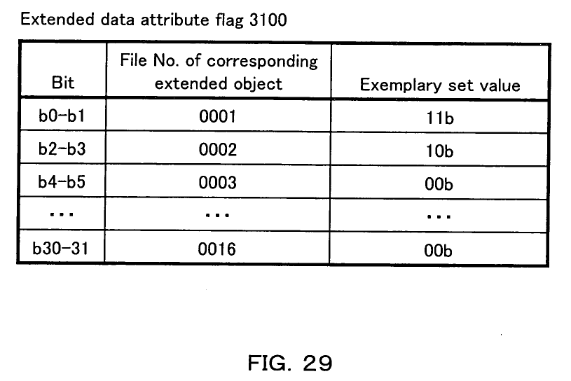

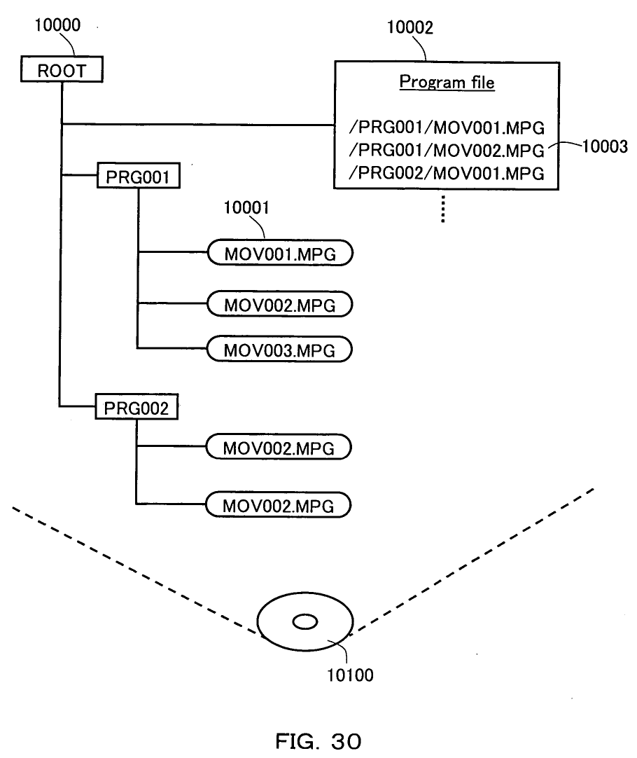

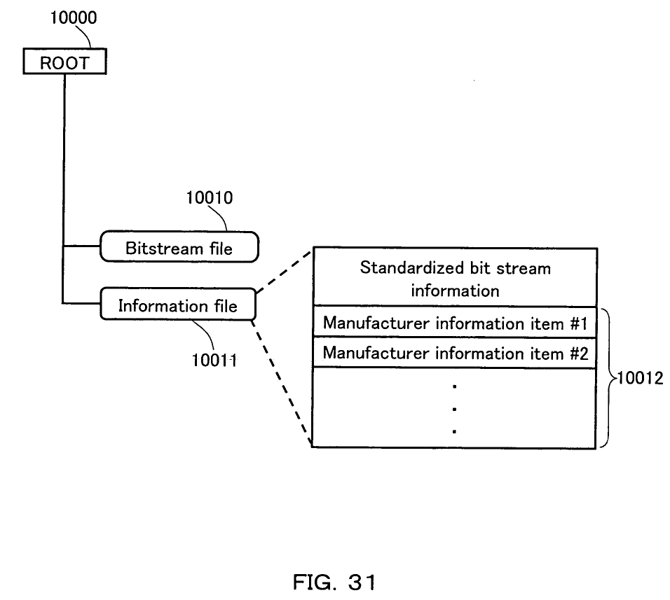

FIG. 29 shows exemplary values set in the RefValidFlag 3100 after the process as shown in FIG. 28.

As an example, FIG. 29 shows set values after a process by recording/reproduction apparatus, in which only programmed reproduction can be processed as an extended object and the other types of extended objects cannot be processed. In the RefValidFlag 3100, bit 2 remains 1b (unchanged), while bit 3 is set to be 0b. Therefore, the reference from this extended object is still present, but the validity of the data is not assured.

As described above, in Embodiment 1, the validity of an entire extended object is managed using the Valid flag 731. On the other hand, in Embodiment 3, the lower bit of the RefValidFlag 3100 can be used to manage the validity for each media object and MO_INFO, so that only a portion of an extended object is updated, but not the entire extended object. Thus, more flexible management can be achieved.

Further, similar to what has been described with reference to FIG. 24, by examining the value of the lower bit of the RefValidFlag 3100 (i.e., a process corresponding to step S304 of FIG. 24 is performed), the validity of information of an extended object is determined. When the information is valid, a normal process is performed. When the validity is not assured, appropriate exception handling, write protect, displaying a message to the user, or the like can be performed.

The above-described feature is effective for improvement of the efficiency of the data amount of a media object manager to be processed, particularly when the data amount is large, since all the data is not necessarily updated.

Although the RefValidFlag 3100 has a length of 32 bits in Embodiment 3, other data lengths or variable length can be used. By using variable length, a change in the number of extended objects can be efficiently managed.

In the foregoing description, bits 0 and 1 of the RefValidFlag 3100 correspond to an extended object having a file number of 0001. The correspondence between each bit of the RefValidFlag 3100 and an extended object is not limited to this. For example, upper bits of the RefValidFlag 3100, such as bits 30 and 31, may correspond to the extended object having a file number of 0001.

Although the RefValidFlag 3100 is associated with extended objects using the file numbers thereof, the association may be achieved in other manners.

### EMBODIMENT 4

In Embodiment 4, a method for managing the validity of an extended object using update date-and-time information, will be described.

As shown in FIG. 15A, the media object manager 320 is provided with the ModTime 702 indicating update date-and-time thereof. It is assumed that every time the contents of the media object manager 320 is updated, the value of the ModTime 702 is updated.

Also, an extended object is provided with a ModTime 813 indicating update date-and-time thereof. Similarly, a value of the ModTime 813 is updated every time the contents of the extended object are updated.

It should be noted that the contents of only an extended object that can be processed by the recording/reproduction apparatus of the present invention are updated as described in the procedure of FIG. 23 (step S205 of FIG. 23).

Therefore, when a media object is subjected to an edit operation or like, the media object manager 320 is updated and only an extended object that can be processed is updated.

As a result, the value of the ModTime 702 matches the ModTime 813 of the extended object that can be processed. An extended object that cannot be processed is not updated, and therefore, the ModTime 813 thereof is not updated, so that the ModTime 813 no longer matches the value of the ModTime 702.

Therefore, in the recording/reproduction apparatus of the present invention, it can be determined whether or not an extended object is valid by comparing the value of the ModTime 702 with the value of the ModTime 813 before processing the extended object.

This feature has an effect similar to that of determination of whether or not the value of a Valid flag is 1b as shown in FIG. 24 (step S304 of FIG. 24).

Although the program manager 330 is used as an extended object in the description with reference to FIG. 17, other extended objects can provide a similar effect by using the same field as that of the ModTime 813.

It should be noted that the MO_INFOs 740, 2000 and 3000 in the above-described example may be called “Property Entries”. Also, the MO_INFOs 740, 2000 and 3000, and together with the MoType 741 and the MoRef 742, may be called “Binary File Identifiers”. The MoUniqueID 743 may be called an “entry_number”. An extended object may be called a “manufacturer-specific file” or a “private file”. The RefValidFlag 3100 may be called “vflags”.

Although, in any of the above-described embodiments, a recording/reproduction apparatus and a recording medium are described using an optical disc medium such as a DVD as an example, the medium is not particularly limited. Other recording apparatuses and recording media, such as a hard disk drive using other magnetic recording media, magneto-optical disc media, and the like, may be used.

As described above, according to the recording/reproduction apparatus and method of the present invention, data addition for an extended function can be performed efficiently. This feature is desirable for recording/reproduction apparatuses such as consumer electronics apparatuses such as DVD recorders, DVD camcorders, etc. that have a limited hardware resource. Further, when a media object is edited or deleted, data inconsistency is minimized even if an extended function or an extended object that is not defined in a unified standard and is not supported by a certain recording/reproduction apparatus, is present, and an appropriate data processing method can be determined. Thus, it is possible to avoid a malfunction of an apparatus, system stop, a reduction in convenience for the user, and the like.

Particularly, for consumer recording/reproduction apparatuses, such as DVD recorders, DVD camcorders and the like that use a removable recording medium, such a recording medium is assumed to be recorded/reproduced using those that are produced by a plurality of manufacturers and thus have different extended functions. Therefore, a larger effect can be obtained by the recording/reproduction apparatus and method of the present invention.

It should be noted that the above-described embodiments are mainly directed to a recording apparatus, a reproduction apparatus, a recording medium, a recording method, and a reproduction method according to some aspects of the present invention. According to other aspects of the present invention, a program for controlling a recording operation of the recording apparatus, a program for controlling a reproduction operation of the reproduction apparatus, a medium providing these programs (program product), and a data structure recorded on a recording medium can be provided. These aspects of the present invention could be understood by those skilled in the art from the above-described embodiments.

### INDUSTRIAL APPLICABILITY

The present invention can be applied to, but are not limited to, recording media, such as a DVD and the like, and recording/reproduction apparatuses, such as a DVD recorder, a DVD camcorder and the like.

1. A recording apparatus, comprising:
a recording section for recording information onto a recording medium;
a file system processing section for managing the information as a file using file system information having a directory hierarchy structure capable of being referenced using a path name;
a contents management information processing section for managing the directory and the file using contents management information; and
an extension information processing section for managing extension information with respect to the directory and the file,
wherein the contents management information includes:
media object management information for referencing the directory and the file using object reference information obtained by converting the path name; and
extended object management information for managing the extension information,
wherein the directory and the file are associated with the extension information via the object reference information.

2. The recording apparatus according to claim 1, wherein the extended object management information includes consistency state management information for managing a state of the directory and the file with the extension information corresponding thereto, and
when an operation is performed with respect to the directory and the file, the extension information of a type that can be processed is updated, the extension information of a type that cannot be processed is not updated, and the consistency state management information is updated depending on a state of the consistency of the directory and the file with the extension information.

3. The recording apparatus according to claim 2, wherein
the consistency state management information is provided for each media object management information, and
the consistency state management information includes, for each extension information, at least information indicating the presence or absence of reference relationship from the extension information to the directory and the file, and information indicating whether or not the consistency of the directory and the file with the extension information corresponding thereto is assured.

4. The recording apparatus according to claim 1, wherein
the contents management information includes first update date-and-time information,
the extension information includes second update date-and-time information,
when the media object management information is updated, the first update date-and-time information is updated, the same value of that of the first update date-and-time information is set to the second update date-and-time information of the extension information of a type that can be processed, and the second update date-and-time information of the extension information of a type that cannot be processed is not updated.

5. A recording method, comprising:
recording contents information as a file onto a recording medium using file system information having a directory hierarchy structure capable of being referenced using a path name;
recording contents management information for managing the directory and the file, onto the recording medium; and
recording extension information with respect to the directory and the file, onto the recording medium,
wherein the contents management information includes:
media object management information for referencing the directory and the file using object reference information obtained by converting the path name; and
extended object management information for managing the extension information,
wherein the recording method comprises associating the directory and the file with the extension information via the object reference information.

6. The recording method according to claim 5, wherein the extended object management information includes consistency state management information for managing a state of the directory and the file with the extension information corresponding thereto, and
when an operation is performed with respect to the directory and the file, the recording method comprises updating the extension information of a type that can be processed, and updating the consistency state management information depending on a state of the consistency of the directory and the file with the extension information.

7. The recording method according to claim 6, wherein
the consistency state management information is provided for each media object management information, and
the consistency state management information includes, for each extension information, at least information indicating the presence or absence of reference relationship from the extension information to the directory and the file, and information indicating whether or not the consistency of the directory and the file with the extension information corresponding thereto is assured.

8. The recording method according to claim 5, wherein
the contents management information includes first update date-and-time information,
the extension information includes second update date-and-time information,
the recording method comprises:
updating the media object management information;
updating the first update date-and-time information; and
setting the same value of that of the first update date-and-time information to the second update date-and-time information of the extension information of a type that can be processed.

9. A recording medium recording information, recorded with:
file system information for managing the information as a directory hierarchy structure capable of being referenced using a path name;
contents management information for managing the directory and the file; and
extension information with respect to the directory and the file,
wherein the contents management information includes:
media object management information for referencing the directory and the file using object reference information obtained by converting the path name; and
extended object management information for managing the extension information,
wherein the directory and the file are associated with the extension information via the object reference information.

10. The recording medium according to claim 9, wherein the extended object management information includes consistency state management information for managing a state of the directory and the file with the extension information corresponding thereto.

11. The recording medium according to claim 10, wherein
the consistency state management information is provided for each media object management information, and
the consistency state management information includes, for each extension information, at least information indicating the presence or absence of reference relationship from the extension information to the directory and the file, and information indicating whether or not the consistency of the directory and the file with the extension information corresponding thereto is assured.

12. The recording medium according to claim 9, wherein
the contents management information includes first update date-and-time information,
the extension information includes second update date-and-time information,
when the consistency of the directory and the file with the extension information corresponding thereto is assured, the same value is recorded in the first update date-and-time information and the second update date-and-time information.

13. A reproduction apparatus for reproducing information from the recording medium according to claim 10, the apparatus comprising:
a reproduction section for reproducing the information from the recording medium;
a file system processing section for processing the file system information;
an extension information processing section for processing the extension information; and
a contents management information processing section for processing the contents management information,
wherein when processing the extension information corresponding to the directory and the file, the extension information processing section determines a procedure for processing the extension information according to a value set in the consistency state management information.

14. A reproduction apparatus for reproducing information from the recording medium according to claim 12, the apparatus comprising:
a reproduction section for reproducing the information from the recording medium;
a file system processing section for processing the file system information;
an extension information processing section for processing the extension information; and
a contents management information processing section for processing the contents management information,
wherein when processing the extension information corresponding to the directory and the file, the extension information processing section determines a procedure for processing the extension information according to whether or not the first update date-and-time information matches the second update date-and-time information.

15. A reproduction method for reproducing information from the recording medium according to claim 10, the method comprising:
reproducing the information from the recording medium;
processing the file system information;
processing the extension information; and
processing the contents management information,
wherein the step of processing the extension information comprises determining a procedure for processing the extension information according to a value set in the consistency state management information before processing the extension information corresponding to the directory and the file.

16. A reproduction method for reproducing information from the recording medium according to claim 12, the method comprising:
reproducing the information from the recording medium;
processing the file system information;
processing the extension information; and
processing the contents management information,
wherein the step of processing the extension information comprises determining a procedure for processing the extension information according to whether or not the first update date-and-time information matches the second update date-and-time information before processing the extension information corresponding to the directory and the file.

17. A program for controlling a recording operation of a recording apparatus for recording information onto a recording medium, the program comprising an instruction for causing the recording apparatus to execute:
recording contents information as a file onto a recording medium using file system information having a directory hierarchy structure capable of being referenced using a path name;
recording contents management information for managing the directory and the file, onto the recording medium; and
recording extension information with respect to the directory and the file, onto the recording medium,
wherein the contents management information includes:
media object management information for referencing the directory and the file using object reference information obtained by converting the path name; and
extended object management information for managing the extension information,
wherein the program further comprises an instruction for causing the recording apparatus to execute associating the directory and the file with the extension information via the object reference information.

18. The program according to claim 17, wherein the extended object management information includes consistency state management information for managing a state of the directory and the file with the extension information corresponding thereto, and
when an operation is performed with respect to the directory and the file, the program comprises an instruction for causing the recording apparatus to execute updating the extension information of a type that can be processed, and updating the consistency state management information depending on a state of the consistency of the directory and the file with the extension information.

19. The program according to claim 18, wherein
the consistency state management information is provided for each media object management information, and
the consistency state management information includes, for each extension information, at least information indicating the presence or absence of reference relationship from the extension information to the directory and the file, and information indicating whether or not the consistency of the directory and the file with the extension information corresponding thereto is assured.

20. The program according to claim 17, wherein
the contents management information includes first update date-and-time information,
the extension information includes second update date-and-time information,
the program comprises an instruction for causing the recording apparatus to execute:
updating the contents management information;
updating the first update date-and-time information; and
setting the same value of that of the first update date-and-time information to the second update date-and-time information of the extension information of a type that can be processed.

21. A program for controlling a reproduction operation of a reproduction apparatus for reproducing information from the recording medium according to claim 10, the program comprising an instruction for causing the reproduction apparatus to execute:
reproducing the information from the recording medium;
processing the file system information;
processing the extension information; and
processing the contents management information,
wherein the program comprises an instruction for causing the reproduction apparatus to execute, in the step of processing the extension information, determining a procedure for processing the extension information according to a value set in the consistency state management information before processing the extension information corresponding to the directory and the file.

22. A program for controlling a reproduction operation of a reproduction apparatus for reproducing information from the recording medium according to claim 12, the program comprising an instruction for causing the reproduction apparatus to execute:
reproducing the information from the recording medium;
processing the file system information;
processing the extension information; and
processing the contents management information,
wherein the program comprises an instruction for causing the reproduction apparatus to execute, in the step of processing the extension information, determining a procedure for processing the extension information according to whether or not the first update date-and-time information matches the second update date-and-time information before processing the extension information corresponding to the directory and the file.

23. A program providing medium recording the program according to any claim 17 on a medium.

24. A data structure recorded on a recording medium, comprising:
file system information for managing contents information recorded on the recording medium as a directory hierarchy structure capable of being referenced using a path name;
contents management information for managing the directory and the file; and
extension information with respect to the directory and the file,
wherein the contents management information includes:
media object management information for referencing the directory and the file using object reference information obtained by converting the path name; and
extended object management information for managing the extension information,
wherein the directory and the file are associated with the extension information via the object reference information.

25. The data structure according to claim 24, wherein the extended object management information includes consistency state management information for managing a state of the directory and the file with the extension information corresponding thereto.

26. The data structure according to claim 25, wherein
the consistency state management information is provided for each media object management information, and
the consistency state management information includes, for each extension information, at least information indicating the presence or absence of reference relationship from the extension information to the directory and the file, and information indicating whether or not the consistency of the directory and the file with the extension information corresponding thereto is assured.

27. The data structure according to claim 24, wherein
the contents management information includes first update date-and-time information,
the extension information includes second update date-and-time information,
when the consistency of the directory and the file with the extension information corresponding thereto is assured, the same value is recorded in the first update date-and-time information and the second update date-and-time information.
